(19) United States
(12) Patent Application Publication
(10) Pub. No.: US 2026/0037996 A1
(43) Pub. Date: Feb. 5, 2026

(54) MODELLED QUESTIONNAIRE GENERATION

(71) Applicant: Honeywell International Inc., Charlotte, NC (US)

(72) Inventors: Ankit Singh, Apex, NC (US); Lakshminarayana Paila, Frisco, TX (US); Zillery Fortner, Florence, SC (US); Jignesh Kansara, Mira-Bhayandar (IN)

(21) Appl. No.: 18/789,704

(22) Filed: Jul. 31, 2024

(51) Int. Cl. G06Q 30/0203

(52) U.S. Cl. CPC G06Q 30/0203

(57) ABSTRACT

Techniques for modelling a questionnaire are disclosed. Textual content received in a query is converted into a set of query vectors. Relevance metric is then computed for each elementary vector, in a set of elementary vectors based on semantic similarity between each query vector in the set of query vectors and each elementary vector in the set of elementary vectors. A set of relevant elementary vectors is accordingly identified. Modelling of a questionnaire, having hierarchically-linked questions, is then triggered with set of relevant elementary vectors. The modelled questionnaire includes an opening question and a plurality of subsequent questions, each being determined based on a response associated with an immediately preceding question thereto. The subsequent questions are determined until a response to a question, from amongst the subsequent questions, provides a required insight associated with an aspect. A questionnaire delivery signal is then generated to cause rendering of the modelled questionnaire.

### BACKGROUND

Generally, entities may develop and provide various offerings in the form of services, products, platforms, and/or other possible modes to their customers. Such entities may be, for example, creators, manufacturers, distributors, maintainers, or providers of such offerings. In some instances, circumstances may arise where one or more offerings may need to be withdrawn, modified, or replaced. For example, a process to recall a product may have to be initiated by the entity responsible for the offering or by any other relevant parties. The reasons for such actions may vary widely and may include, but are not limited to, quality concerns, safety considerations, performance issues, regulatory changes, market conditions, or strategic decisions. In some cases, the withdrawal, modification, or replacement processes may serve to address potential risks, modify one or more features of the offerings, ensure compliance, or respond to evolving needs or standards.

### BRIEF DESCRIPTION OF DRAWINGS

FIGS. 1A to 1C illustrate a block diagram of a computing environment comprising a system, according to an example implementation of the present subject matter.

FIG. 2 illustrates a block diagram of the system, according to an example implementation of the present subject matter.

FIG. 3 illustrates a block diagram of a computing environment comprising the system, according to another example implementation of the present subject matter.

FIG. 4 illustrates a block diagram of the Graphical User Interface, according to one example implementation of the present subject matter.

FIG. 5 illustrates a block diagram of a modelled questionnaire, according to one example implementation of the present subject matter.

FIG. 6 illustrates a method for assisting in modelling of a questionnaire, according to an example implementation of the present subject matter.

FIGS. 7A and 7B illustrate a method for modelling a questionnaire, according to another example implementation of the present subject matter.

FIG. 8 illustrates a non-transitory computer-readable medium for modelling a questionnaire and determining a requisite insight associated with an aspect, in accordance with an example of the present subject matter.

### DETAILED DESCRIPTION

Entities or organizations may design and provide a range of offerings to users or customers. Examples of the offerings may include, but are not limited to, services, products, and platforms that may be offered by the organization. The organizations may be, for example, designers, developers, manufacturers, distributors, assemblers, testers, maintainers, and providers of such offerings. The organizations may also generate or create different types of documents for such offerings. Examples of such documents may include, but are not limited to, analytical reports, review reports, quality reports, datasheets, specification sheets, manuals, guides, drawings and/or images, project reports, and catalogues. The documents, in one example, may include descriptive content that may provide detailed information about the offerings or one or more batches of the offerings.

Generally, the organizations may design and provide their offerings to the users or customers. However, in many cases, there can be scenarios where one or more decisions are required to be made for the one or more offerings. For example, there may be scenarios where a decision is required to be made on whether one or more offerings are required to be withdrawn, modified, replaced, or recalled. In one example, a manufacturer of a product may have to decide on whether to recall a product. The decision may have to be made due to a variety of possible reasons or factors. The reasons may be related to, for example, quality concerns, safety considerations, performance issues, regulatory changes, market conditions, strategic decisions, or any other possible issue that may potentially harm consumers or expose the organization to serious consequences. Once it has been decided that the offerings are required to be withdrawn, modified, replaced or recalled, one or more processes or workflows may be initiated to implement or effect the withdrawal, modification, replacement, or recall of the one or more offerings.

Thus, decision-making is generally among the initial steps or phases where a decision is made on whether to initiate any withdrawal, modification, replacement, or recall processes for the one or more offerings or one or more batches of the offerings. For example, a recall decision-making process may be initiated to decide whether one or more offerings or one or more batches of the offerings are required to be recalled. In one example, the decision-making process may be initiated in response to receiving any feedback or intimation regarding any defect, fault, or irregularity in the one or more offerings, or batches thereof. The feedback or intimation may be received, in one example, from a buyer or consumer of the offerings. In another example, the feedback or intimation may be received through internal monitoring processes, such as testing and quality check processes. Based on the outcomes of such decision-making processes, determinations to initiate further workflows or processes, for example, the recall processes may be made.

Typically, there exist various techniques that may help, for example, an organization reach any decision or conclusion with respect to the one or more offerings. The decisions may be related to, for example, whether the one or more offerings are required to be withdrawn, modified, replaced or recalled. One such technique includes creation of a questionnaire. The questionnaire may include multiple questions that may be answered to conclude or determine whether, for example, the recall processes are required to be initiated to recall the offerings. In one example, the questionnaire may be in the form of a decision tree that, at the end, may indicate the decision.

However, there exist several drawbacks and limitations to such techniques. For example, the workflow of preparation of the questionnaires and responding to the questions requires efforts and involvement of multiple individuals. Examples of the individuals may include, but are not limited to, department leads, project managers, business admins, developers, quality analysis individuals, and testers. The questionnaire may typically include questions spanning across different domains, such as technical domains, logistic stages, or manufacturing processes. Therefore, multiple users, associated with their respective domains, may be involved in the preparation of the questions or the questionnaire. Further, the questions may then have to be channeled to other users or skilled professionals, such as expert individuals, based on the domain in which they are experts or are associated. Such individuals may then have to manually, and a number of times, access and comb through the descriptive information associated with the offerings to derive responses or answers, and accordingly reach a decision. Thus, the preparation of such questionnaires is a manual and time-consuming process.

Further, the quality of questions, responses, and coverage of necessary topics or domains is highly dependent on the skills of such individuals, as different individuals may have varying skills. For example, since different individuals may have knowledge or experience with different topics or domains, it may be desirable that question(s) related to different domains or topics may be prepared by individuals associated with such domains or topics. Further, it may also be desirable that question(s) related to different topics or domains are provided to individuals expert in corresponding domains or topics to receive appropriate responses for the question(s). Thus, for the questionnaire to be sufficiently indicative of an appropriate and accurate decision, the identification of a correct or appropriate individual becomes necessary. Also, appropriate and accurate decision-making may be dependent on the skills and knowledge of individuals framing the questions and the individuals responding to such questions.

Typically, the identification of expert individuals is a manual process and each of the questions may have to be manually channeled or sent to the respective expert individuals. The task of manually preparing the questionnaire along with their responses may thus become complicated and time-consuming as the individuals capable or responsible for answering the questions are required to be manually identified. Thus, manual preparation of the questionnaire is complex as it involves identifying and assigning individuals with the appropriate expertise to answer specific questions within the document. The complication may further increase with the increase in the number of individuals, questions, domains, and variety and complexity of the offerings. Also, with increase in the volume or size of the descriptive information, and coverage of more topics and domains, it may become a challenging and time-consuming task for one or more individuals as they have to comb through such information to identify appropriate responses for the questions.

In another example, the questions and the answers may be prepared by a single user. For example, the user may define a set of questions to decide whether to recall a product. Once the set of questions is prepared, the user may access and analyse different documents or descriptive information associated with the offerings to derive answers and reach a decisive conclusion. However, in this case, to derive appropriate and accurate decisions, the user may be required to have sufficient skills and knowledge of multiple domains or topics. For example, it may be difficult for an individual to have vast or complete knowledge about multiple products.

Further, the manual processes may have a considerable probability of error. For example, as the preparation of the questionnaire is dependent on the skills and knowledge of individuals, it may be possible that the one or more individuals, while preparing the questionnaire, may fail to add or correctly describe important questions, follow necessary business rules, and other important steps that would help in deriving decisions accurately. Inaccurate decisions, or false positive conclusions, may lead to the initiation of, say, recall processes that may actually not be required. In another example, where the recalls may actually be necessary, conclusions may be derived to not initiate the recall process. Thus, such manual processes may lead to false positive and false negatives, thereby affecting the accuracy with which correct or desired conclusions may be derived.

Further, the one or more individuals may have to access, or launch, one or more documents or descriptive information associated with the offerings repeatedly to conduct manual analysis for making a decision. However, accessing or relaunching the one or more documents multiple times may impact resource consumption. For example, as the documents may be stored in a data repository, multiple access or launch requests would increase the number of access and read operations that the data repository may experience, potentially increasing load on the data repository and, thereby affecting the request handing capability, for example, total number of read requests that may be executed by the data repository.

Thus, the conventional solutions include several drawbacks. For example, the process includes manual and time-consuming processes of preparing questionnaires, analysis of descriptive contents, identification of expert individuals, and channeling the questions to expert individuals from various domains. Also, challenges may be faced in developing comprehensive or insightful questions due to limited individual knowledge across different topics or domains. Further, coordination between multiple individuals from various domains is required to seamlessly create effective questionnaires with appropriate responses. As a result, the decision-making processes are complex and lead to additional delays in decision-making. Further, there may be inaccuracies in manually developed questionnaires. The inaccuracies may be due to, for example, non-involvement of important or insightful questions, necessary business rules, or omission of steps crucial for reaching accurate decisions. Thus, the probability of deriving accurate decisions may be impacted as there may be chances of false positive conclusions leading to unnecessary product recalls or false negative conclusions failing to initiate necessary recalls.

The present subject matter discloses techniques for generating a modelled questionnaire that may assist in effectively deriving a decision for an offering. The modelled questionnaire may include questions that may be, in one example, hierarchically-linked questions that may assist in concluding or reaching a required decision. Examples of the required decision may include, but are not limited to, withdrawal, modification, replacement, or recall decisions for the offering. Further, examples of the offering may include, but are not limited to, a service, a product, and a platform.

According to one example, a query corresponding to the offering may be received. In one example, the query may be received from a user through a Graphical User Interface (GUI) and may include textual content relevant to the offering. The query may be, in one example, a question related to the offering. Further, the textual content in the query may be encoded into a set of query vectors representing the textual content. The set of query vectors, in one example, may collectively and numerically represent the textual content embedded in the query.

Further, a vector database may include a set of elementary vectors derived based on descriptive information associated with the offering. The descriptive information may include information contained within various documents and materials associated with the offering. The descriptive information may encompass, for example, details, specifications, performance data, feedback, usage instructions, production and manufacturing details, characteristic data, visual representations, and other relevant content that describes or provides insights into the nature, features, characteristics, performance, manufacturing, design, or other attributes related to the offering. The descriptive information may also encompass, for example, details about faulty and previously withdrawn, modified, replaced or recalled offerings.

Thus, the descriptive information may be information that may be usable for deriving an insight associated with an aspect related to the offering. That is, data or details, encompassed in the descriptive information, may be analysed or interpreted to gain a meaningful understanding or insight about one or more aspects related to the offering. In other words, the descriptive information may potentially be usable for extraction of valuable knowledge, decisions, conclusions, and inferences about some aspect related to the offering. Thus, in one example, the descriptive information may be usable for extracting knowledge or conclusion, i.e., insight, about a decision, i.e., aspect, for the offering. Withdrawal, modification, replacement, or recall may be some of the aspects related to the offering, and the insight may be knowledge, conclusion, decision, or other similar derivatives that may be related to the aspects, and drawn on the basis of the descriptive information.

In one example, the descriptive information may be encoded into the set of elementary vectors, where the set of elementary vectors may collectively and numerically indicate the descriptive content. The set of encoded vectors may be stored, in one example, in the vector database. Further, a relevance metric may then be computed for each elementary vector in the set of elementary vectors. In one example, the relevance metric may be determined based on a semantic similarity or relationship between each elementary vector, in the set of elementary vectors, and each query vector in the set of query vectors. The relevance metric may quantify the semantic similarity or relationship between each elementary vector, in the set of elementary vectors, and each query vector in the set of query vectors.

Based on the relevance metric computed for each elementary vector, a set of relevant elementary vectors may be identified from amongst the set of elementary vectors. The set of relevant elementary vectors may include elementary vectors determined to be semantically similar or relatable with the query vectors. In one example, the relevance metric computed for each elementary vector may be compared with a threshold relevance metric. Based on the comparison, the set of relevant elementary vectors may be identified. For example, the elementary vectors having the relevance metric equal to or more than the threshold relevance metric, may be selected for being included in the set of relevant elementary vectors. Further, as the elementary vectors represented the descriptive information, the set of relevant elementary vectors may be representative of selective descriptive information, from amongst the descriptive information, pertinent to the query.

Modelling of a questionnaire may then be triggered based on the set of relevant elementary vectors. The questionnaire, in one example, may include questions that may be hierarchically-linked question in relation to the insight associated with the aspect. In one example, to model the questionnaire, an opening question may be determined based on the set of relevant elementary vectors. The opening question may be determined in relation to the insight associated with the aspect. In one example, the opening question may be a broad question directed towards determining a decision to recall. As the opening question may be directed towards determining the decision to recall, the opening question may thus be in relation to the insight associated with the aspect. Thus, the opening question may be determined concerning the insight associated with the aspect.

Further, a plurality of subsequent questions may be determined. In one example, each of the plurality of subsequent questions may be determined based on a probable response to an immediately preceding question thereto. For example, based on a response, that may be deduced based on the selective descriptive information, to a question, the next or subsequent question may be determined. The subsequent questions may be determined in such a manner that proximity to the insight associated with the aspect is gradually increased as compared to the immediately preceding question. For instance, each subsequent question may be a question, as compared to the immediately preceding question, whose response may be closer to the desired or requisite insight associated with the aspect, i.e., the decision to recall the offering.

In one example, the subsequent questions may be determined until a response to at least one question, from among the subsequent questions, provides the requisite insight associated with the aspect. In other words, the subsequent questions may be determined until the response to at least one question indicates a concluding insight associated with the aspect, i.e., a concluding decision to recall the offering. The concluding decision may indicate, for example, either a positive decision to initiate the recall process for the offering or a negative decision indicating not to initiate the recall process for the offering.

Once the questionnaire has been modelled, a questionnaire delivery signal may be rendered to cause rendering of the modelled questionnaire. In one example, the modelled questionnaire may be a decision tree indicating the concluding insight associated with the aspect related to the offering.

The present subject matter may address the problems associated with conventional techniques. According to one example, the present subject matter may facilitate automated generation of a modelled questionnaire that may assist in accurately deriving conclusions for the offering. The techniques disclosed by the present subject matter may require no, or significantly reduced, manual intervention. Thus, the questionnaire may include no manual errors or inefficiencies and other manual limitations as discussed above. For example, the derivation of false positives and false negative decisions may be reduced. Also, the decision-making process may become fast. Also, the questionnaire includes hierarchically-linked questions that may systematically narrow down to the required decision or aspect, thereby improving the decision-making process. That is, the subsequent questions are determined based on probable responses to preceding questions, thereby gradually increasing proximity to the desired insight. Also, the generation of questions may continue until a concluding insight or decision is reached, thus ensuring a definitive outcome. The modelled questionnaire may thus assist in effectively deriving decisions, such as withdrawal, modification, replacement, or recall decisions for offerings. As a result, the withdrawal, modification, replacement, or recall processes may be expedited. Also, manual repeated accessing and launching of the documents may be avoided, thus reducing resource utilization.

Further, a wide range of descriptive information about the offerings, including details on faulty and previously withdrawn/recalled items, may be used, thereby providing a robust knowledge base for making more informed and accurate decisions. Furthermore, encoding textual content into vectors allows for numerical representation, enabling more efficient processing and comparison. Also, computation of relevance metrics based on semantic similarity between query vectors and elementary vectors may help in ensuring that the most pertinent information is identified for modelling the questionnaire, thereby improving the correctness and relevance of the questions with respect to the insight associated with the aspect.

The modelled questionnaire, in one example, may be represented as a decision tree, thus providing a clear and intuitive visualization of the decision-making process. Thus, automatic modelling of the questionnaire, based on relevant or descriptive information may reduce manual efforts in decision-making processes.

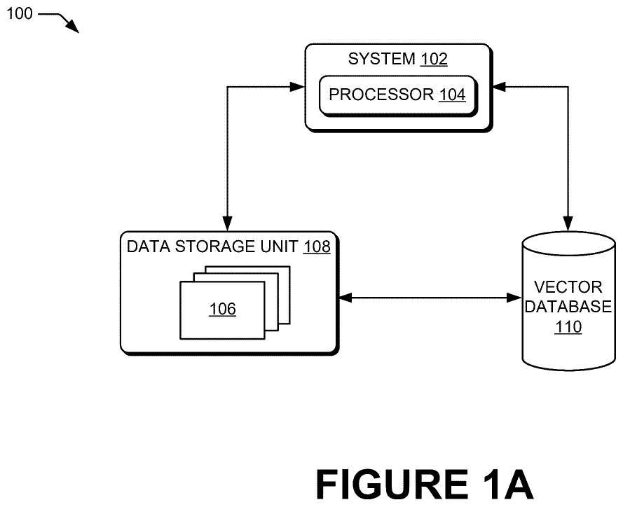

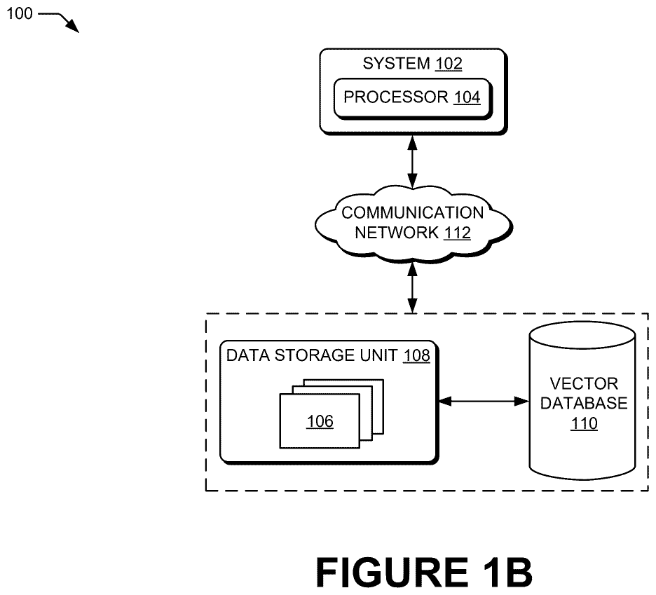

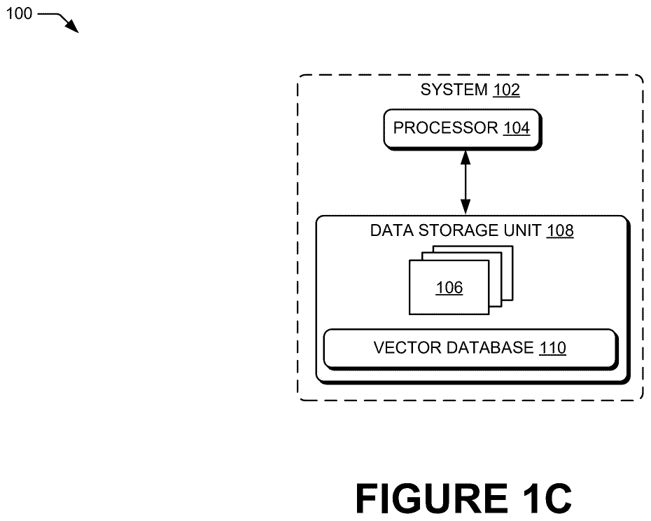

The above techniques are further described with reference to FIGS. 1A to 8. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIGS. 1A to 1C illustrate a block diagram of a computing environment 100 comprising a system 102, according to an example implementation of the present subject matter. In one example, the computing environment 100 may be associated with one or more organizations where multiple computing devices may be communicably coupled with each other. In another example, the computing environment may be associated with a service or platform that may be accessed by one or more users or organizations for assistance in modelling a questionnaire and/or determining a requisite insight associated with an aspect for one or more offerings.

The system 102 may be implemented in the computing environment 100 and may be communicably coupled with one or more of the computing devices associated with the computing environment 100. In one example, the system 102 may facilitate the modelling of the questionnaire to determine the requisite insight associated with an aspect related to the one or more offerings. In one example, the system 102 may include a processor 104. The processor 104 may be configured to, in one example, model the questionnaire and determine the requisite insight associated with the aspect. The processor 104 may be implemented as a dedicated processor, a shared processor, or a plurality of individual processors, some of which may be shared. Examples of the processor 104 may include, but are not limited to, microprocessors, microcomputers, microcontrollers, digital signal processors, central processing units, state machines, logic circuitries, Artificial Intelligence (AI) based processors, processing circuitries including one or more modules or engines, and/or any other devices that may manipulate signals and data based on computer-readable instructions.

In one example, the system 102 may be implemented as a platform or a service that may accessed or utilized by one or more organizations, individuals associated with the one or more organizations, or one or more users for determining the requisite insight associated with the aspect related to the one or more offerings by modelling the questionnaire. In another example, the system 102 may be implemented as a set of hardware or computing devices that may be communicably coupled with each other to effect the modelling and determination of the requisite insight associated with the aspect. In yet another example, the system 102 may be implemented as a combination of software programs and computing devices that may collectively operate to facilitate the modelling and determination of the requisite insight associated with the aspect.

In one example, the system 102 may be private and dedicatedly associated with an organization. The organization, or individuals associated with the organization, may utilize the system 102, in one example, for assistance in modelling the questionnaire and determining the requisite insight associated with the aspect for the one or more offerings, or one or more batches of the offerings. In another example, the system 102 may be assessed remotely by the organization, individuals associated with the organization, or independent one or more users for modelling and determination of the requisite insight associated with the aspect for the one or more offerings.

Further, in one example, the system 102 may be implemented as a user assistance platform, or at least a part thereof, that may be utilized by one or more users for intuitively modelling or generating the questionnaire and determining the requisite insight associated with the aspect. The one or more users may include general audience, for example, any users having the intent to generate the questionnaire and determine the requisite insight associated with the aspect related to the one or more offerings.

Examples of the offerings may include, but are not limited to, services, products, and platforms that may have been sold, deployed, stored, commissioned, ready-to-use, available in the market, being utilized by one or more users or organizations, are under testing or development or service, or at any stage in the supply chain. Further, examples of the organizations may include, but are not limited to, designers, developers, manufacturers, sellers, distributors, assemblers, testers, maintainers, quality and standard monitoring organizations, labs, testing facilities, research and development organizations, and providers of such offerings.

Further, in one example, each offering, or a batch of offerings, may have different types of data and/or documents 106 associated therewith. In one example, the users or organizations associated with the offerings may generate or create different types of data and/or documents 106. Examples of the data and/or documents 106 may include, but are not limited to, analytical reports, review reports, quality reports, test results, datasheets, specification sheets, manuals, guides, drawings and/or images, project reports, and catalogues. In one example, the documents 106 may also include data available or stored in a server or a cloud storage platform associated with the one or more users of organizations. In yet another example, the documents 106 may also include data, associated with the offerings, that is available on the internet.

In one example, the computing environment 100 may include a data storage unit 108 that may store the documents 106 related to the offerings. The data storage unit 108 may be communicably coupled with the system 102. The data storage unit 108 may be implemented by one or more physical storage devices, virtual storage instances, or a combination thereof. In one example, the data storage unit 108 may be a server or a cloud-based storage platform that may store the data or documents 106 associated with the offerings. The data storage unit 108 may be accessed by the system 102 to access the data or documents 106 associated with the offerings. The data storage unit 108 may thus be any source of the data or documents 106.

In one example, the data storage unit 108 may include one or more sub-storage units. In another example, the data storage unit 108 may be a single storage unit. Further, the data storage unit 108, in one example, may implement distributed data storage techniques. For example, the data or documents 106 may be stored in a distributed manner across the one or more storage units. In another example, the data or documents 106 may be replicated on the one or more storage units. Distribution and data replication may enhance fault tolerance against loss of the data or documents 106, for example, due to failure or loss of connection with any of the storage units.

Further, the data or documents 106 may include, or at least indicate, descriptive information associated with the offerings. For example, the data or document 106 may indicate details, specifications, performance data, feedback, usage instructions, production and manufacturing details, characteristic data, visual representations, business rules, regulatory compliance requirements, safety requirements and rules, log reports, quality compliance data or records, market analysis data, and other relevant information that describes or provides insights into the nature, features, characteristics, performance, manufacturing, compliance, design, or other attributes related to the offerings. The descriptive information may also encompass, for example, details about faulty and previously withdrawn, modified, replaced or recalled offerings or batches of the offerings. Thus, the data or documents 106 may indicate the descriptive information usable for deriving an insight associated with an aspect related to the offerings. The descriptive information may be analysed to gain a meaningful understanding or insight about one or more aspects related to the offerings. In other words, the descriptive information may potentially be usable for the extraction of valuable knowledge, decisions, conclusions, and inferences about some aspects related to the offerings. Thus, in one example, the descriptive information may be usable for extracting knowledge or conclusion, i.e., insight, about a decision, i.e., aspect, for the offerings, or one or more batches of the offerings. Withdrawal, modification, replacement, or recall may be some of the aspects related to the offerings, and the insight may be knowledge, conclusion, decision, or other similar derivatives that may be related to the aspects, and drawn from the descriptive information.

In one example, the computing environment 100 may include a vector database 110 communicably coupled with the system 102. The vector database 110 may store the descriptive information in the form of vectors. For example, the vector database 110 may include vectors that may be derived based on the descriptive information associated with each of the offerings, or one or more batches of the offerings. The vectors derived based on the descriptive information may hereinafter interchangeably be referred to as a set of elementary vectors. The set of elementary vectors may include one or more elementary vectors derived based on the descriptive information associated with corresponding offerings, or one or more batches of the corresponding offerings. Thus, for descriptive information associated with each of the offerings, or for each batch thereof, a set of elementary vectors may be stored in the vector database 110. The set of elementary vectors may be derived by using any known techniques that may be capable of converting textual and non-textual data into vectors.

The set of elementary vectors, in one example, may numerically represent the descriptive information associated with each of the offerings, or one or more batches of the offerings. In one example, it may also be possible that the vector database 110 may include the set of elementary vectors representing the descriptive information associated with only the offerings, or batches of the offerings, that may have previously been withdrawn, recalled, replaced, modified, or have been identified to be faulty. Thus, the vector database 110 may be a collection of the elementary vectors representing the descriptive information associated with the offerings, or batches of the offerings.

The vector database 110, in one example, may be implemented by one or more physical storage devices, virtual storage instances, or a combination thereof. In another example, the vector database 110 may be a server or a cloud-based platform that may store the vectors. The vector database 110 may be accessed by the system 102 to access the elementary vectors stored therein.

Further, the data storage unit 108 and the vector database 110 may store data in an indexed manner. For example, the documents 106, or corresponding descriptive information, and vectors corresponding to the descriptive information for same or similar type or batch of offerings may be saved together. For instance, the documents 106, corresponding descriptive information, and corresponding vectors may be indexed based on the offerings or the batch of the offerings. For example, the documents 106, descriptive information, associated with the same or similar products may be stored together in the data storage unit 108 and the corresponding vectors may be stored together in the vector database 110. Such offering-based or batch-based indexing of the documents 106, the descriptive information, and the vectors may assist in convenient and quick searching of the documents 106, the descriptive information, and the vectors.

The system 102, the data storage unit 108, and the vector database 110 may be communicably coupled with each other to exchange data, instructions, and signals. In one example, the system 102, the data storage unit 108, and the vector database 110 may be in direct communication with each other, as illustrated in FIG. 1A. In another example, the system 102, the data storage unit 108, and the vector database 110 may be communicably coupled with each other over a communication network 112, as illustrated in FIG. 1B, and may exchange data, instructions, and signals over the communication network 112. For instance, the system 102, the data storage unit 108, and the vector database 110 may be distributed across different locations and/or platforms and may be communicably coupled by the communication network 112 to assist inter-communications. Examples of such communication network 112 may include, but are not limited to, local area network (LAN), wide area network (WAN), the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network 112 may include various network entities, such as transceivers, gateways, and routers. In an example, the communication network 112 may include any communication network that uses any of the commonly used protocols, for example, Hypertext Transfer Protocol (HTTP), and Transmission Control Protocol/Internet Protocol (TCP/IP).

In another example, the data storage unit 108 and the vector database 110 may be a part of the system 102. Also, in one example, the data storage unit 108 may include the vector database 110, as illustrated in FIG. 1C. In addition to the configurations discussed above, other arrangements, connections, and configurations between various entities of the computing environment 100 may also be possible, though not illustrated.

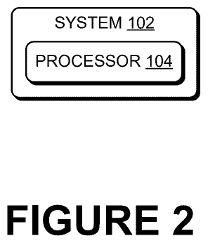

FIG. 2 illustrates a block diagram of the system 102, according to an example implementation of the present subject matter. FIG. 2 will be discussed in conjunction with FIGS. 1A to 1C for the sake of brevity. In one example, the system 102 may assist in determining a requisite insight associated with an aspect related to an offering by modelling a questionnaire. The system 102 may include the processor 104 that may assist in modelling the questionnaire and determining the insight associated with the aspect related to the offering.

In one example operation, the processor 104 may receive an activation signal including a query corresponding to the offering. In one example, the activation signal may be a communication received by the processor 104 from a Graphical User Interface communicably coupled with the processor 104. Further, the query may be an input received in the communication received from the Graphical User Interface. The query may include textual content relevant to the offering. In one example, the query may be a question corresponding to the offering.

In response to receiving the query, the processor 104 may encode the textual content into a set of query vectors. The set of query vectors may include one or more vectors representing the textual content. The set of query vectors may be, in one example, numerical vectors derived based on the textual content of the query.

Further, the processor 104 may compute a relevance metric for each elementary vector in a set of elementary vectors. In one example, the set of elementary vectors may be the set of elementary vectors stored in the vector database 110. From the vector database 110, the processor 104 may refer or retrieve to the set of elementary vectors derived from the descriptive content associated with the offering. As discussed above, the descriptive information may include information contained within various documents and materials associated with the offering and may thus be usable for deriving an insight associated with an aspect related to the offering. Withdrawal, modification, replacement, or recall may be some of the aspects related to the offering, and the insight may be knowledge, conclusion, decision, or other similar derivatives about the aspects, that may be derived based on the descriptive information. In one example, the descriptive information may be encoded into the set of elementary vectors, where the set of elementary vectors may collectively and numerically indicate the descriptive content, as discussed above.

Further, for each elementary vector, in the set of elementary vectors, the processor 104 may compute the relevance metric. In one example, the processor 104 may compute the relevance metric by determining a semantic relationship between each elementary vector, in the set of elementary vectors, and each query vector in the set of query vectors. The relevance metric may indicate an extent of semantic similarity or relationship between each elementary vector, in the set of elementary vectors, and each query vector in the set of query vectors.

Once the relevance metric has been computed for each elementary vector in the set of elementary vectors, the processor 104 may identify a set of relevant elementary vectors. Based on the computed relevance metric computed for each elementary vector, the processor 104 may identify the set of relevant elementary vectors. The set of relevant elementary vectors may include elementary vectors determined to be semantically relatable with the query vectors in the set of query vectors. The set of relevant elementary vectors may thus include elementary vectors that may probably be semantically similar to the query vectors, and thus the query that was received by the processor 104.

Further, as the set of relevant elementary vectors is identified from amongst the set of elementary vectors, the set of relevant elementary vectors may indicate a portion of the descriptive information from amongst the descriptive information. The portion of the descriptive information, represented by the set of relevant elementary vectors, may hereinafter interchangeably be referred to as selective descriptive information. Further, as the selective descriptive information is represented by the set of relevant elementary vectors having semantic relationship with the set of query vectors, the selective descriptive information may thus be relevant or pertinent to the query.

Based on the set of relevant elementary vectors, the processor 104 may proceed to trigger modelling of a questionnaire. In one example, the questionnaire may include questions being hierarchically-linked questions in relation to the insight associated with the aspect. In one example, the processor 104 may utilize algorithms and/or advanced learning models that may be configured to understand the context or semantics of the set of relevant elementary vectors, and accordingly model the questionnaire based on the given set of relevant elementary vectors.

In one example, to model the questionnaire, the processor 104 may determine an opening question based on the set of relevant elementary vectors. The opening question may be determined in relation to the insight associated with the aspect. In one example, the opening question may be a broad question related to the insight associated with the aspect. For example, the opening question may be a broad question directed towards determining a decision to recall for the offering.

Further, the processor 104 may determine a plurality of subsequent questions. In one example, each of the plurality of subsequent questions may be determined based on a probable response to an immediately preceding question thereto. For example, the processor 104 may deduce a response to the opening question based on logical analysis and assessment of the selective descriptive information. Based on the response, the processor 104 may determine a subsequent question. The subsequent questions may be determined in such a manner that proximity to the insight associated with the aspect is gradually increased as compared to the immediately preceding question. For example, the opening question may have a broad scope whereas the subsequent question may have a narrower scope and may be more pointed towards the insight associated with the aspect as compared to the opening question. Thus, each subsequent question may be a question whose response may be closer to the desired or requisite insight associated with the aspect, for example, a response to the decision to recall the offering.

The processor 104, in one example, may continue to determine the subsequent questions until a response to at least one question, from among the subsequent questions, provides the requisite insight associated with the aspect. That is, the processor 104 may continue to determine the subsequent questions until the response to at least one question indicates a concluding insight associated with the aspect, for example, a concluding response or decision to recall the offering.

Once the questionnaire has been modelled, the processor 104 may generate a questionnaire delivery signal to cause rendering of the modelled questionnaire. In one example, the questionnaire delivery signal may cause rendering of the modelled questionnaire as the hierarchically-linked questions, indicating the concluding insight associated with the aspect related to the offering.

Thus, the present subject matter may assist in automated generation of the modelled questionnaire to assist in deriving conclusions for the offering with reduced, or no, manual intervention. The disclosed techniques may also minimize errors and expedite decision-making processes. Further, the questionnaire includes hierarchically-linked questions to systematically narrow down to required decisions or aspects, ensuring a definitive outcome. Also, a wide range of descriptive information, including details on faulty and previously withdrawn/recalled items, may be used, thus providing a robust knowledge base for informed decisions.

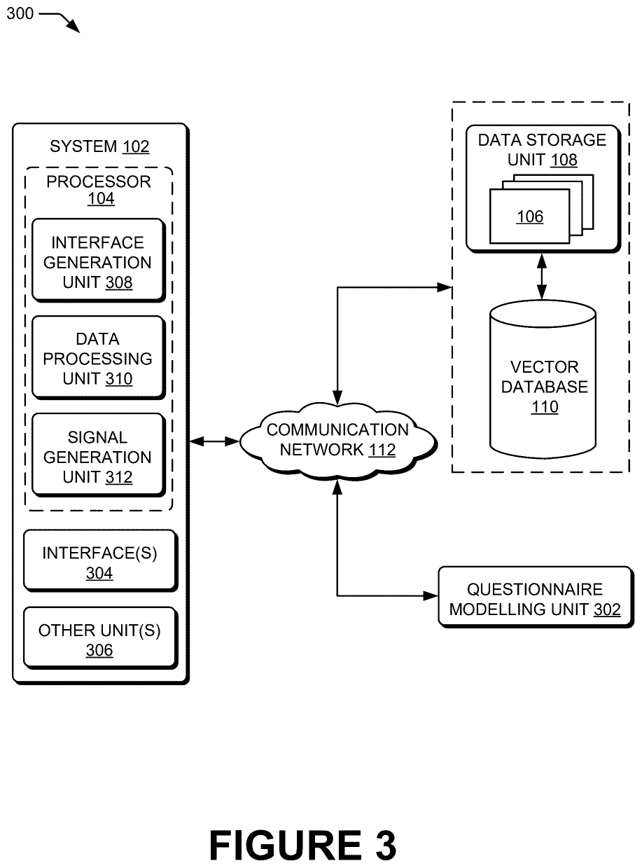

FIG. 3 illustrates a computing environment 300 comprising the system 102, according to another example implementation of the present subject matter. FIG. 3 may be discussed in conjunction with FIGS. 1A to 1C and would be incorporated herein for reference and for the sake of brevity. In one example, the computing environment 300 may be similar to the computing environment 100.

In one example, the computing environment 300 may include the system 102, the data storage unit 108, the vector database 110, and a questionnaire modelling unit 302. The system 102, the data storage unit 108, the vector database 110, and the questionnaire modelling unit 302 may be communicably coupled with each other over the communication network 112 to exchange data, instructions, and signals.

In one example, the system 102 may assist in modelling the questionnaire to determine the requisite insight associated with the aspect related to the one or more offerings, as discussed above with reference to FIGS. 1A to 1C.

Further, the computing environment 300 may include the data storage unit 108 that may store the data or documents 106 related to the one or more offerings, as discussed above with reference to FIGS. 1A to 1C. The data storage unit 108 may be accessed by the system 102 to access the data or documents 106 associated with the offerings. In one example, the data storage unit 108 may store the data or documents 106 related to all the offerings being offered by the organization. In another example, the data storage unit 108 may store the data or documents 106 pertinent to the offerings, being offered by the organization, that have mostly been subject to faults, withdrawals, replacements, repairs, or recalls.

In one example, the data or documents 106 may be created and stored in the data storage unit 108 by one or more organizations associated with the offerings. The one or more organizations may be creators, manufacturers, distributors, maintainers, or providers of the offerings. in another example, the data or documents 106 may be created and stored in the data storage unit 108 by one or more users associated with the offerings. for example, the data or documents 106 may include user inputs, feedback, modification requests, and other inputs from the one or more users for the offerings. The one or more users may be consumers of the offerings being offered by the one or more organizations. Thus, the data or documents 106 may be vast data about such offerings and may indicate details, specifications, performance data, feedback, usage instructions, production and manufacturing details, characteristic data, visual representations, business rules, regulatory compliance requirements, safety requirements and rules, log reports, quality compliance data or records, market analysis data, and other relevant information that describes or provides insights into the nature, features, characteristics, performance, manufacturing, compliance, design, user feedback, and other attributes related to the offerings.

The computing environment 300 may further include the vector database 110 communicably coupled with the system 102. The vector database 110 may store the set of elementary vectors derived based on the descriptive information associated with each of the one or more offerings, or one or more batches of the offerings, as discussed above with reference to FIGS. 1A to 1C.

In one example, the set of elementary vectors may be stored in the vectors database 110 before the computation of the relevance metric. For example, the vector database 110 may be a pre-conditioned database having the set of elementary vectors, derived based on the descriptive information associated with each of the one or more offerings, or one or more batches of the offerings. In one example, the vector database 110 may store the set of elementary vectors derived based on the descriptive information associated with all the offerings being offered by the organization. In another example, the vector database 110 may store the set of elementary vectors derived based on the descriptive information pertinent to the offerings that have mostly been subject of faults, withdraws, replacements, repairs, or recalls.

The set of elementary vectors may be derived by using any known techniques that may be capable of converting textual and non-textual data into vectors. For example, one or more deep learning models or natural language processing (NLP) techniques may be used for encoding the descriptive information into the set of elementary vectors. Known word embedding techniques may also be used for encoding the descriptive information into the set of elementary vectors. In one example, the processor 104 may utilize such known techniques for encoding the descriptive information. Once encoded, the encoded content, i.e., the set of elementary vectors may be stored in the vector database 110. In another example of a pre-conditioned scenario, the descriptive information may have already been encoded into the set of elementary vectors and stored in the vector database 110.

Further, the computing environment 300 may include the questionnaire modelling unit 302 communicably coupled with the system 102, the data storage unit 108, and the vector database 110. In one example, the questionnaire modelling unit 302 may be remote to the system 102, as illustrated in FIG. 3, and may be triggered by the system 102 to trigger the modelling of the questionnaire. Further, though not illustrated, it may also be possible that the questionnaire modelling unit 302 may be a part of the system 102 itself and may be communicably coupled with the processor 104. In yet another example, the questionnaire modelling unit 302 may be deployed in the processor 104 to enable the modelling of the questionnaire.

In one example, the questionnaire modelling unit 302 may be an advanced learning model capable of modelling the questionnaire upon receiving inputs and being triggered. Examples of the advanced learning model may include, but are not limited to, large language models, deep learning models, and natural language processing engines. In another example, the advanced learning model may either be an unsupervised large language model or a supervised large language model. The unsupervised large language model, in one example, may be a generic large language model that may not have been trained on any specific or proprietary data, such as the data or documents 106. On the other hand, the supervised large language model, in one example, may be a large language model that may be trained based on specific or proprietary data, such as the data or documents 106. For example, the supervised large language model may be trained with the data or documents 106, a set of known questions with respect to the offerings, previously or historically modelled questionnaires in relation to the insight associated with the aspect related to the offerings, previously or historically derived responses for each question in the historically modelled questionnaires, aspects derived from each of the historically modelled questionnaires, and the data or descriptive information associated with the offerings for which the questionnaires were previously or historically modelled. The supervised large language model may also be fed with a large number of decision trees having questions, their responses, and conclusions or aspects derived at the end. Feeding such data may enable the advanced learning model to understand the patterns and architecture of data, responses, the questionnaires, and the logical interrelationships therebetween. The training process may also include fine-tuning the model to return expected responses by supplying a large number of questionnaires and their expected corresponding responses. The fine-tuning process may help the model learn the patterns and architecture of data, responses, the questionnaires.

Thus, from such data, the advanced learning model may learn the architecture or structure and logical interrelationships between data, questions, and responses. The model may thus be capable of deriving or developing logic for modelling the questionnaires and logic with which the data or documents 106 may be analyzed for determining probable responses for the questions included in the questionnaire. The training process may thus enable the model, or the questionnaire modelling unit 302, to generate similar structures based on new input data and derive probable responses by logically analysing the data or documents 106.

In some cases, the training process may include manual supervision, where human experts, such as individuals associated with the one or more organizations associated with the offerings, may provide feedback or corrections to improve the model's performance. This manual supervision may help in refining the model's understanding of complex or nuanced aspects of questionnaire modelling.

Further, the system 102, in one example, may include interface(s) 304 and other unit(s) 306. The interface(s) 304 may allow the communicably coupling the system 102 with one or more other entities, such as the data storage unit 108, the vector database 110, the questionnaire modelling unit 302, and the communication network 112. The connection or coupling may be through a wired (e.g., Local Area Network, i.e., LAN) connection or through a wireless connection (e.g., Bluetooth®, Wi-Fi). The interface(s) 304 may also enable intercommunication between different logical as well as hardware components of the system 102.

Further, the other unit(s) 306 may include, in one example, a power supply unit, a communication unit, and a memory. The power supply unit may, for example, manage distribution or supply of electrical current within the system 102 for functioning of the system 102. Further, the communication unit may be, in one example, a wireless communication unit. Examples of the communication unit may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication unit may also include one or more antennas to enable wireless transmission and reception of data and signals. The communication unit may allow the system 102 to exchange data, instructions, and signals with the data storage unit 108, the vector database 110, the questionnaire modelling unit 302, and the communication network 112.

Furthermore, the memory may be a computer-readable medium, examples of which include volatile memory (e.g., RAM), and/or non-volatile memory (e.g., Erasable Programmable read-only memory, i.e., EPROM, flash memory, etc.). The memory may be an external memory, or internal memory, such as a flash drive, a compact disk drive, an external hard disk drive, or the like.

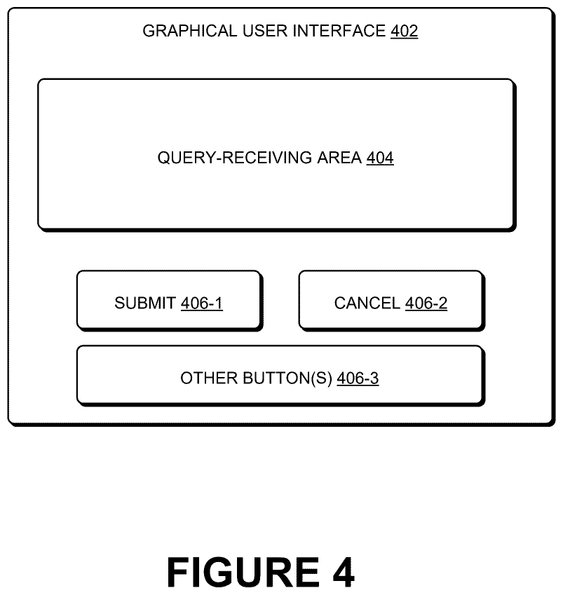

In one example operation, the processor 104 may receive an activation signal including a query corresponding to an offering, such as the offering discussed above. In one example, the activation signal may be received from a Graphical User Interface 402, as illustrated in FIG. 4. FIG. 4 illustrates a block diagram of the Graphical User Interface 402, according to one example implementation of the present subject matter. FIG. 4 will be discussed in conjunction with FIG. 3.

In one example, the processor 104, or an interface generation unit 308 of the processor 104, may cause rendering of the Graphical User Interface 402. The Graphical User Interface 402 may be a digital interface with which one or more users may be able to interact. The Graphical User Interface 402 may be rendered, for example, as a software page or window, a web page, or a set of web pages accessible by the one or more users, on any computing device capable of displaying the Graphical User Interface 402. The one or more users may be, for example, individuals associated with one or more organizations associated with the offerings. In another example, the one or more users may be the common users. For instance, the one or more users may be consumers of the offering.

In one example, the Graphical User Interface 402 may be a REACT-based Graphical User Interface or platform. The Graphical User Interface may be built, for example, with REACT Javascript library. REACT may provide the ability to detect interactions occurring with the Graphical User Interface 402 or elements associated therewith. The elements may be, for example, a query-receiving area 404 and one or more buttons that may be rendered on the Graphical User Interface 402. The REACT may include event handlers, for example, onClick and onSubmit that may be attached to the Graphical User Interface 402 or the elements. Upon interaction, the event handlers may be triggered and appropriate actions may then be initiated based on the interaction.

For example, the query-receiving area 404 may be an area of the Graphical User Interface 402 where the one or more users may enter the query. In one example, the query-receiving area 404 may be a text box that may enable the one or more users to enter a textual query. Further, the one or more buttons may include, in one example, a submit button 406-1 and a cancel button 406-2. Upon interacting with the submit button 406-1, the event handler associated with the submit button 406-1 may be triggered and may cause generation of a communication, referred to as the activation signal, including the query provided by the one or more users in the query-receiving area 404. The activation signal may thus be generated by the Graphical User Interface 402 and received by the processor 104, or the interface generation unit 308 of the processor 104 that causes the rendering of the Graphical User Interface 402. Further, upon interaction with the cancel button 406-2, the event handler associated therewith may cause generation of a communication indicating that no query has been received or the query entered in the query-receiving area 404 is not to be communicated to the processor 104.

In one example, the Graphical User Interface 402 may also include other button(s) 406-3 that may enable the one or more users to perform other actions. For example, the other button(s) 406-3 may include a close button that may enable the user to close the Graphical User Interface 402. In another example, the other button(s) 406-3 may include a re-submission button that may enable the one or more users to submit a fresh query. Similarly, other elements may also be included in the Graphical User Interface 402 to provide different functionalities to the one or more users.

Thus, the processor 104, or a data processing unit 310 of the processor 104, may receive the activation signal that may include the query corresponding to the offering. In one example, the query may include textual content relevant to the offering. In one example, the query may be provided in a natural language by the one or more users and may be about the offering. For example, the user may provide “Is there any report of contamination due to XYZ product?”, where XYZ may indicate one or more details about the product. The one or more details may be, for example, a given name or a generic name of the product.

The processor 104, or the data processing unit 310 of the processor 104, may encode the textual content into the set of query vectors representing the textual content. The processor 104, or the data processing unit 310 of the processor 104, may utilize any known techniques to convert or encode the textual content into the set of query vectors. For example, one or more deep learning models or natural language processing (NLP) techniques may be used for encoding the textual content into the set of query vectors. in another example, word embedding techniques may be used for encoding the textual content into the set of query vectors. The set of query vectors, in one example, may numerically represent the textual content. For example, the set of query vectors may numerically represent the query “Is there any report of contamination due to XYZ product?”.

Once the set of query vectors have been derived from the textual content, the processor 104, or the data processing unit 310 of the processor 104, may compute the relevance metric for each of the elementary vectors in the set of elementary vectors stored in the vector database 110. In one example, the processor 104 may compare each query vector in the set of query vectors with each of the elementary vectors in the set of elementary vectors stored in the vector database 110. The processor 104, for example, may communicate with the vector database 110 to access the set of elementary vectors stored therein.

In one example, the processor 104 may compute the relevance metric based on the semantic relationship between each of the elementary vectors, in the set of elementary vectors, and each of the query vectors, in the set of query vectors. The semantic relationship may be, for example, semantic similarity or correlation between each of the elementary vectors, in the set of elementary vectors, and each of the query vectors, in the set of query vectors. The relevance metric may quantify how semantically similar or related all the vectors may be with respect to each other. In one example, the processor 104 may compute the relevance metric using any technique capable of evaluating the semantic similarity between the vectors. For example, the processor 104 may be configured to determine cosine similarity that may indicate a measure of an angle between two vectors (such as between an elementary vector and a query vector). In another example, the processor 104 may be configured to determine Euclidean distance between, i.e., a straight-line distance between two vectors. Similarly, the processor 104 may be configured to determine the relevance metric by measuring the semantic similarity between two vectors using other techniques. The other techniques may be, for example, Manhattan distance, Jaccard similarity, person correlation, and hamming distance. In another example, the processor 104 may utilize specialized tools or programming libraries. Examples of the libraries may include, but are not limited to, Natural Language Toolkit (NLTK), spaCy, and other natural language processing-based libraries or models.

Thus, the relevance metric, in one example, may be a score indicating an extent or level of semantic similarity between each elementary vector, in the set of elementary vectors, and each query vector in the set of query vectors. For example, an elementary vector being semantically similar to a query vector may have a higher relevance metric or score as compared to another elementary vector that may not be semantically similar to that query vector. Therefore, for each elementary vector, in the set of elementary vectors, the processor 104 may compute the relevance metric.

Further, based on the relevance metric computed for each elementary vector in the set of elementary vectors, the processor 104, or the data processing unit 310 of the processor 104, may identify a set of relevant elementary vectors from amongst the set of elementary vectors. In one example, to identify the set of relevant elementary vectors, the processor 104 may compare the relevance metric, computed for each elementary vector, with a threshold relevance metric. Based on the comparison, the processor 104 may identify the set of relevant elementary vectors from amongst the set of elementary vectors. The threshold relevance metric may indicate a minimum score required for the elementary vector to be considered semantically similar and be added to the set of relevant elementary vectors. If the relevance metric for an elementary vector is equal to or greater than the threshold relevance metric, the elementary vector may be sufficiently or considerably semantically similar to at least one query vector in the set of query vectors. The elementary vector may be selected or identified for being added to the set of relevant elementary vectors. However, if the relevance metric for the elementary vector is less than the threshold relevance metric, the elementary vector may not be considered sufficiently or considerably semantically similar to at least one query vector in the set of query vectors. The elementary vector may not be selected or identified for being added to the set of relevant elementary vectors.

In one example, the threshold relevance metric may be a predefined score. For example, the individuals associated with the organization associated with the offering may define the threshold relevance metric. In another example, the Graphical User Interface 402 may enable the one or more users or the individuals to define the threshold relevance metric. Further, in one example, the threshold relevance metric may be modifiable based on semantic similarity requirements. For example, the threshold relevance metric may be dynamically modified to redefine the minimum score required by an elementary vector to be considered semantically similar to at least one quest vector. Increasing the threshold relevance metric, in one example, may result in the selection of elementary vectors that may be strongly semantic to at least one query vector, thereby improving the selection or identification criteria.

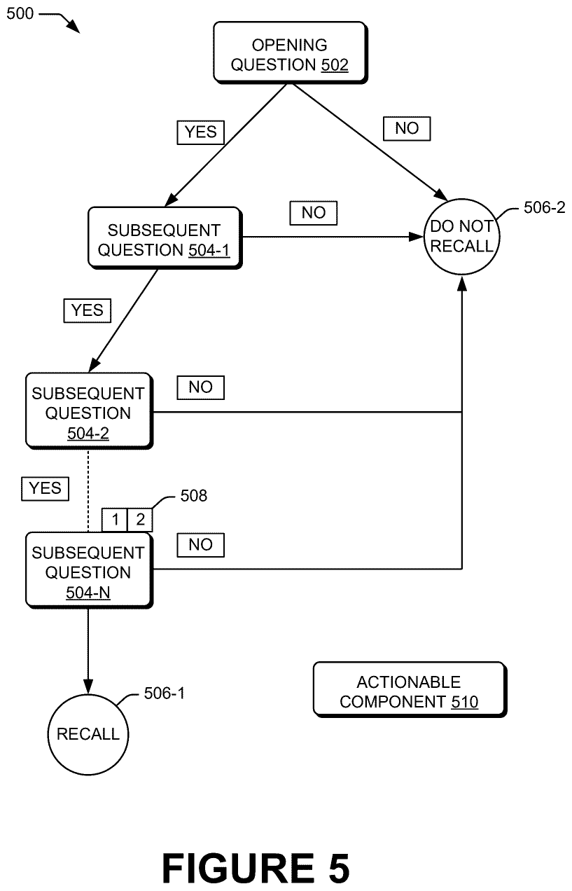

Once the set of relevant elementary vectors is identified, the processor 104, or the data processing unit 310, may proceed to trigger modelling of a questionnaire based on the set of relevant elementary vectors. The modelled questionnaire may include questions that may be hierarchically-linked questions in relation to the insight associated with the aspect. FIG. 5 illustrates a block diagram of a modelled questionnaire 500, according to one example implementation of the present subject matter. FIG. 5 will be discussed in conjunction with FIG. 3.

In one example, the processor 104 may trigger modelling of the questionnaire 500 to frame questions, based on the set of relevant elementary vectors, that may be hierarchically-linked questions. The processor 104, or the data processing unit 310, may utilize algorithms and pre-trained large language models to understand the architecture and semantics of the set of relevant elementary vectors, allowing them to generate questions. For example, the processor 104 may analyse the set of relevant elementary vectors using a Large Language Model (LLM) to identify architecture, key information, patterns, and context to formulate relevant questions. In another example, the processor 104 may analyse syntactic and semantic relationships between each elementary vector in the set of relevant elementary vectors to determine the structure and meaning. In another example, the processor 104 may further utilize machine learning models, such as deep learning architectures, that may be pre-trained on vast datasets, as discussed above, to be able to grasp different nuances and context. During the question modelling process, the model may identify important information, infer relationships, and accordingly formulate the questions. The processor 104 may also be configured to incorporate additional strategies, such as rule-based systems or reinforcement learning, to enhance the quality of generated questions.

In another example, the processor 104 may trigger the questionnaire modelling unit 302 for modelling the questionnaire 500. In one example, the questionnaire modelling unit 302 may be remote from the system 102 and communicably coupled with the system 102, as illustrated in FIG. 3. In one example, the processor 104, or the data processing unit 310, may generate a signal that may be communicated to the questionnaire modelling unit 302 for triggering modelling of the questionnaire 500. The signal may include, or at least indicate, the set of relevant elementary vectors. In one example, the interface(s) 304 may enable the system 102 to be communicably coupled with the questionnaire modelling unit 302 over the communication network 112. In another example, though not illustrated, it may also be possible that the questionnaire modelling unit 302 is a part of the system 102. For example, the questionnaire modelling unit 302 is another unit in the processor 104. In another example, the questionnaire modelling unit 302 may be deployed on the processor 104.

In one example, the questionnaire modelling unit 302 may be an advanced learning model capable of modelling the questionnaire upon receiving inputs, as discussed above. Examples of the advanced learning model may include, but are not limited to, large language models, deep learning models, and natural language processing engines. The questionnaire modelling unit 302, based on input, for example the, set of relevant elementary vectors, may model the questionnaire by leveraging the extensive training or diverse sets of data, as discussed above, which may include various examples of questions, their architecture, their context, and their answers or responses.

The questionnaire modelling unit 302 may be configured to process the input to extract relevant information, understand the context, and identify key concepts required to determine the requisite insight associated with the aspect. The questionnaire modelling unit 302 may also be configured to identify decision points within the context. These may be areas where different paths may be taken based on a response derived from the selective descriptive information stored in the data storage unit 108 or the corresponding set of relevant elementary vectors stored in the vector database 110. For each identified decision point, the questionnaire modelling unit 302 may be configured to generate a question, for example, an opening question 502, designed to gather information that may determine the next or subsequent question. Based on a probable response to the initial or opening question, derived by logically analyzing the selective descriptive information encoded as the set of relevant set of elementary vectors, the subsequent question 504-1 may be determined, the subsequent question 504-1 being hierarchically-linked questions with the immediately preceding question, i.e., the opening question 502. The questionnaire modelling unit 302 may continue to generate the subsequent questions iteratively, such as the subsequent question 504-2 . . . 504-N, where N is a natural number. Each subsequent question may be generated based on the probable response (for example, illustrated as “YES” and “NO” in square boxes in FIG. 5), derived for the immediately preceding question, maintaining coherence and relevance. For example, if the response to the subsequent question 504-1 is determined to be “YES” (as indicated in square box located between 504-1 and 504-2), the subsequent question 504-2 may accordingly be determined. Similarly, a plurality of subsequent questions may be determined based on a probable response determined for an immediately preceding question.

Further, each question may be logically progressive, as compared to the immediately preceding question, towards the requisite insight associated with the aspect, such as a decision to RECALL (indicated in a circular block 506-1) or a decision DO NOT RECALL (indicated in another circular block 506-2). Thus, each of the subsequent questions may be increasingly proximate to the insight associated with the aspect as compared to the immediately preceding question. For example, each of the subsequent questions may have a higher degree of relevance with the requisite insight associated with the aspect as compared to the immediately preceding question. In other words, with each of the subsequent questions, the requisite insight associated with the aspect may appear to be more logically approachable or closer to a conclusion, as compared to the immediately preceding question. Further, the questionnaire modelling unit 302 may continue to determine the subsequent questions until the subsequent questions cover all, or at least the majority of, potential scenarios and reach the terminal question, response which may indicate the final decision or outcome, i.e., the requisite insight associated with the aspect.

Thus, in one example, to model the questionnaire, the processor 104 may trigger the questionnaire modelling unit 302. The questionnaire modelling unit 302 may be a large language model, as discussed above. In another example, the questionnaire modelling unit 302 may be a platform through which the large language model may be accessible or usable. Using the questionnaire modelling unit 302, the processor 104 may determine the opening question 502 based on the set of relevant elementary vectors. The opening question 502 may be determined in relation to the insight associated with the aspect. In one example, the opening question 502 may be a broad question directed towards determining whether to recall an offering. As the opening question 502 may be directed towards determining whether to recall the offering, the opening question 502 may thus be in relation to the insight associated with the aspect, for example, the decision to recall. Thus, the opening question 502 may be determined concerning the insight associated with the aspect.

In one example, the opening question 502 may be a broad question related to the insight associated with the aspect. For example, the opening question 502 may be a question directed towards determining whether to recall the offering, such as the XYZ product discussed above. The questionnaire modelling unit 302 may determine the opening question 502, for example, by analysing the structure, content of the selective descriptive information, contextual cues, semantics in the selective descriptive information, and frequently appearing phrases or keywords in the selective descriptive information. The opening question 502 may also be determined by considering critical factor(s) that may be foundational or significant in determining the requisite insight. For example, the questionnaire modelling unit 302 may be configured to determine the critical factors that may prompt the decision to recall, such as safety-related factors and compliance requirements. The above considerations and factors, in one example, may enable the questionnaire modelling unit 302 to determine a broad or general question, i.e., the opening question 502 in relation to the insight associated with the aspect. For example, “Will there be any safety issue in view of contamination due to XYZ product?” may be an opening question.

Further, the questionnaire modelling unit 302 may determine a probable response to the opening question. To determine the probable response, the questionnaire modelling unit 302 may explore or analyze the selective descriptive information to understand relationships between features therein and logically derive the probable response for the opening question 502. In one example, the probable response may be a binary response. For example, the probable response to the opening question 502 may be “YES” or “NO” (as illustrated in FIG. 5) derived by analysis and assessment of the selective descriptive information. For example, if the selective descriptive information indicates reports of injuries caused in past due to contamination caused by the XYZ product, the questionnaire modelling unit 302 may, while analyzing the selective descriptive information, come across such information. The questionnaire modelling unit 302 may thus determine that the probable response to the opening question may be “YES”. However, if the questionnaire modelling unit 302, while analyzing the selective descriptive information, does not find any support for such question, “NO” may be determined as the probable response for the opening question. In another example, the probable response may have more than two responses. For example, the probable response may be “high”, “medium”, or “low” which may be derived based on analysis of the selective descriptive information. Similarly, a questionnaire may be modelled in other architectures also, though not illustrated.

Further, the probable response may, in one example, logically split the selective descriptive information. For example, a portion of the selective descriptive information may be associated with the “YES” response while the other portion of the selective descriptive information may be associated with the “NO” response. As discussed earlier, the selective descriptive information may be encoded as the set of relevant elementary vectors. Thus, the logical splitting of the selective descriptive information may also cause splitting of the set of relevant elementary vectors. In one example, the next or subsequent question, say the subsequent question 504-1, may be derived from such splitted selective descriptive information and by considering the probable response of the immediately preceding question, say the opening question 502. Thus, the modelled questionnaire 500 may start with a broad question, such as the opening question 502, and gradually narrow down the scope with the subsequent question 504-1.

Further subsequent questions may be determined by the questionnaire modelling unit 302 in a similar manner, by further splitting and narrowing the selective descriptive information, based on the probable response derived for the immediately preceding question. Thus, each subsequent question may be narrower and logically closer towards the insight associated with the aspect, as compared to the immediately preceding question. As a result, each subsequent question may be increasingly proximate to the insight associated with the aspect.

Thus, the subsequent questions may be determined in such a manner that proximity to the insight associated with the aspect is gradually increased as compared to the immediately preceding question. For example, the opening question 502 may have a broad scope whereas the subsequent question 504-1 may have a narrower scope and may be more pointed towards the insight associated with the aspect, as compared to the opening question 502. Thus, each subsequent question may be a question whose response may be closer to the desired or requisite insight associated with the aspect, for example, a response to the decision to recall (as illustrated in the circular block 506-1) the offering.

Further, the questionnaire modelling unit 302 may continue to determine the subsequent questions until a response to at least one question, from among the subsequent questions, provides the requisite insight associated with the aspect. That is, the processor 104 may continue to determine the subsequent questions until the response to at least one question indicates a concluding insight associated with the aspect, for example, a concluding response or decision to recall the offering. The response may indicate, for example, either to recall the XYZ product or not to recall the XYZ product.

Once the questionnaire has been modelled, the processor 104, or the data processing unit 310, may receive the modelled questionnaire from the questionnaire modelling unit 302. In response to receiving the modelled questionnaire, the processor 104, or a signal generation unit 312 of the processor 104, may generate a questionnaire delivery signal to cause rendering of the modelled questionnaire. By generating the questionnaire delivery signal, the processor 104 may cause rendering of the modelled questionnaire, such as the questionnaire 500. In one example, the questionnaire delivery signal may include instructions that may cause the rendering of the modelled questionnaire 500. In another example, the questionnaire delivery signal may include a set of computer programs that, upon being executed, may cause the rendering of the modelled questionnaire 500. Further, the questionnaire delivery signal, in one example, may indicate a hierarchy between the questions. For example, the questionnaire delivery signal may indicate the arrangement or order of questions for rendering the modelled questionnaire 500 as hierarchically-linked questions. In one example, the questionnaire delivery signal may cause rendering of the modelled questionnaire 500 as a decision tree having the hierarchically-linked questions.

In one example, the questionnaire delivery signal may be communicated to a computing device for rendering the modelled questionnaire 500 on a display of the computing device, the computing device, in one example, may be communicably coupled with the processor 104 or system 102 via the interface(s) 304 and the communication network 112. The computing device may be associated, for example, with the organization, the individuals associated with the organization, or other common/independent users. Examples of the computing device may include, but are not limited to, a mobile phone, a laptop, and a desktop. In another example, the system 102 may itself have a display device, communicably coupled with the processor 104 via the interface(s) 304. In one example, the modelled questionnaire 500 may be rendered as a REACT-based Graphical User Interface.

Further, as discussed above, the modelled questionnaire 500 may include hierarchically-linked questions. In one example, the hierarchically-linked questions may indicate a hierarchy between the questions. As discussed above, each question may be derived from a probable response to its immediately preceding question. For example, the subsequent question 504-2 may be determined based on a probable response determined for the subsequent question 504-1 thereto. Thus, the subsequent questions 504-1 and 504-2 may be linked with each other based on the probable response. Similarly, the subsequent question 504-N may be determined based on a probable response determined for the subsequent question 504-(N−1) thereto. Thus, the subsequent questions 504-N and 504-(N−1) may be linked with each other. The modelled questionnaire 500, thus formed, may include hierarchically-linked questions.

In one example, the modelled questionnaire 500 may also include the query received from the Graphical User Interface 402. The opening question 502 may be hierarchically-linked with the query. For example, the query may be added before the opening question 502, such that the opening question 502 is hierarchically proximate towards the insight associated with the aspect. For example, as the opening question 502 may be narrower than the query, the opening question 502 may be hierarchically proximate towards the insight associated with the aspect, as compared to the query.

Further, in one example, the processor 104, or the interface generation unit 308 may cause rendering of a feedback option 508, as illustrate in FIG. 5. Though illustrated with the subsequent question 504-N, a feedback option, such as the feedback option 508, may be associated, in one example, with each of the questions. Further, in one example, the feedback option 508 may include two interactive components (labelled as 1 and 2 in FIG. 5). In one example, the interactive components may be digitally rendered interactive buttons, hereinafter referred to as button 1 and button 2.

As the modelled questionnaire 500 may be rendered as a REACT-based Graphical User Interface, each of the buttons 1 and 2 may have event handlers associated therewith. Thus, upon occurrence of an interaction with any of the buttons, the corresponding event handlers may be triggered and a signal, corresponding to the button with which the interaction occurred, may be generated. The signal may be received by the processor 104, or the interface generation unit 308 indicating the button with which the interaction occurred.

In one example, the buttons 1 and 2 may be designated with any functionality that may be required to be performed with respect to the question with which they are associated. In one example, the processor 104 may cause rendering of the feedback option 508 to receive at least one of a positive feedback and a negative feedback, where the buttons 1 and 2 may facilitate submission of feedback for each of the questions in the modelled questionnaire. For example, the button 1 may be designated to indicate the positive feedback and the button 2 may be designated to indicate the negative feedback for a question, say the subsequent question 504-N.

The user may provide feedback by interacting with any of the buttons 1 and 2. For example, if the user determines that the question, say the subsequent question 504-N is acceptable or relevant to the insight associated with the aspect, the user may interact, say click, on the button 1. The positive feedback may thus indicate acceptance of the question. However, if the user determines that the question, say the subsequent question 504-N is unacceptable or irrelevant to the insight associated with the aspect, the user may interact, say click, on the button 2. The negative feedback may thus indicate rejection of the question. In one example, the processor may cause rendering of an updated questionnaire in response to receiving the negative feedback for the question. For example, the processor 104 may cause rendering of a re-framed questionnaire by removing the question for which the negative feedback was received.

Further, in one example, the processor 104 may tune subsequent determination of at least one of the opening question and subsequent questions based on at least one of the positive feedback and the negative feedback. Based on the positive and the negative feedback, the processor 104 may be able to determine whether the questions in the modelled questionnaire are relevant to the insight associated with the aspect. For example, if positive feedback was received for all or the majority of the question, the processor 104, or the questionnaire modelling unit 302, may log such feedback and tune the method or logic to keep determining the subsequent question in a similar manner when the same or similar insight associated with an aspect is required to be determined. However, if negative feedback was received for any, all, or the majority of the question, the processor 104, or the questionnaire modelling unit 302, may log such feedback and tune the method or logic to avoid determining the subsequent question in a similar manner when the same or similar insight associated with an aspect is required to be determined. The positive and the negative feedback may thus be used for tuning the modelling of the questionnaire.

In one example, the processor 104 may also cause rendering of an actionable component 510, as illustrated in FIG. 5, that may enable modification of any of the questions of the modelled questionnaire. In one example, the actionable component 510 may be a button. The actionable component 510 may have an event handler associated therewith. Upon interaction, the event handler may be triggered and generate a signal indicating occurrence of the interaction. The signal generated by actionable component 510 may hereinafter be referred to as a questionnaire modification signal. Thus, the questionnaire modification signal may be indicative of a request to modify at least one of the questions of the modelled questionnaire. In one example, the processor 104 may receive, from the actionable component 510, the questionnaire modification signal. in response, the processor 104 may render the modelled questionnaire in an editable version that may allow modification of any of the questions. Thus, the processor 104 may provide flexibility to conveniently modify the one or more questions of the questionnaire.

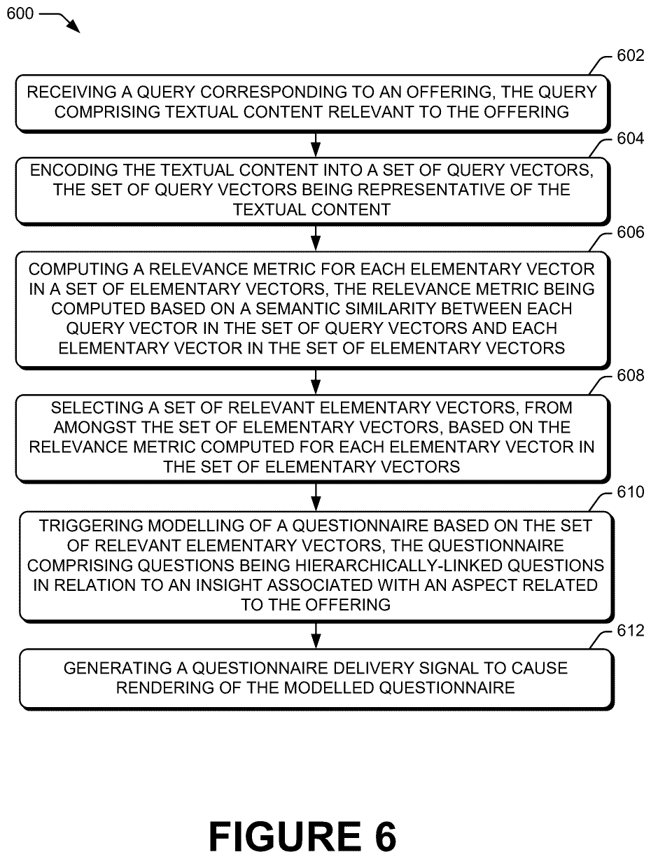

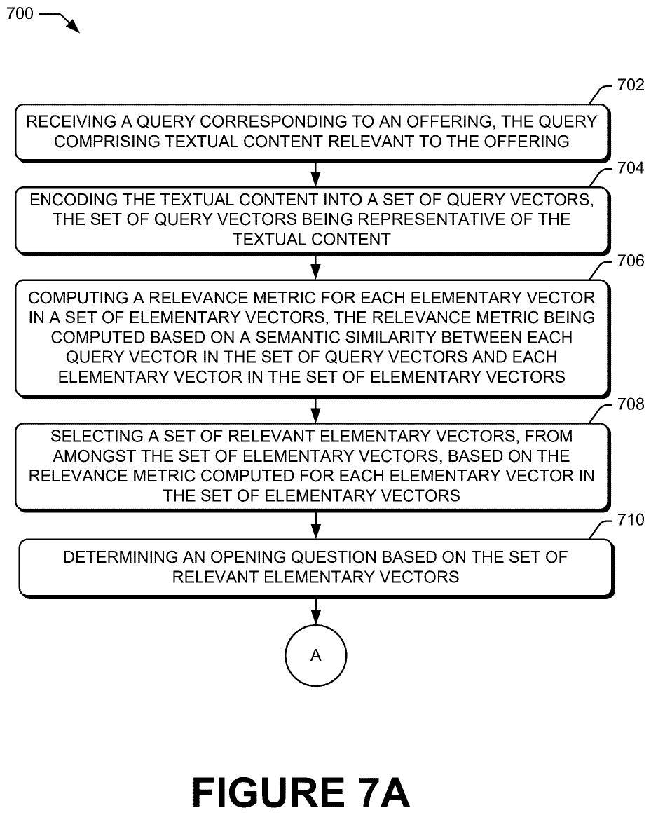

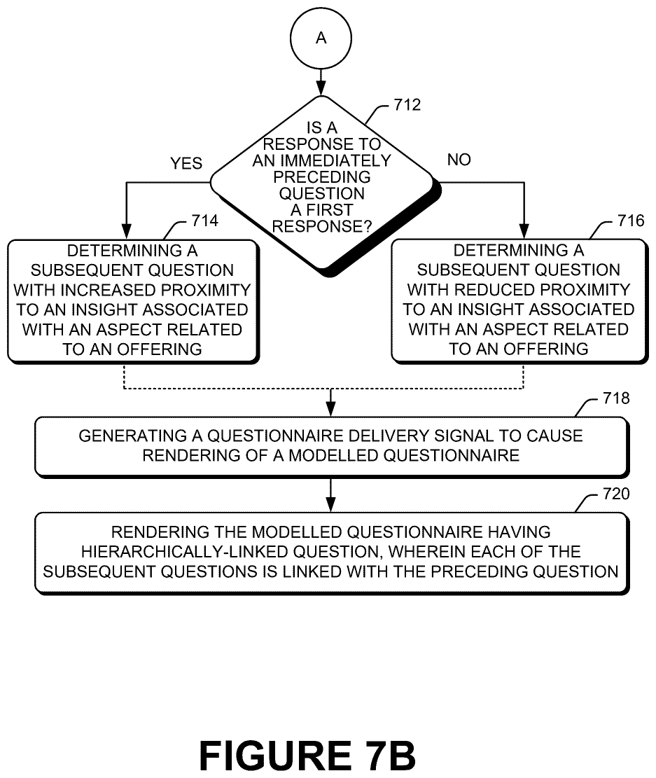

FIGS. 6A to 7B illustrate exemplary methods 600 and 700, respectively, for assisting in generation of content and identification of a destination for the generated content. The order in which the methods are described is not intended to be construed as a limitation, and any number of the described method blocks may be combined in any order to implement the methods, or an alternative method. Furthermore, methods 600 and 700 may be implemented by processing resource or computing device(s) through any suitable hardware, non-transitory machine-readable instructions, or combination thereof.

It may also be understood that methods 600 and 700 may be performed by programmed computing devices, such as the processor 104, as depicted in FIGS. 1A-4. Furthermore, the methods 600 and 700 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. While the methods 600 and 700 are described below with reference to the processor 104 and the system 102 as described above; other suitable systems for the execution of these methods may also be utilized. Additionally, implementation of these methods is not limited to such examples.

FIGS. 6 to 7B illustrate exemplary methods 600 and 700, respectively, for assisting in modelling of a questionnaire. The order in which the methods are described is not intended to be construed as a limitation, and any number of the described method blocks may be combined in any order to implement the methods, or an alternative method. Furthermore, methods 600 and 700 may be implemented by processing resource or computing device(s) through any suitable hardware, non-transitory machine-readable instructions, or combination thereof.

It may also be understood that methods 600 and 700 may be performed by programmed computing devices, such as the processor 104, as depicted in FIGS. 1A-3. Furthermore, the methods 600 and 700 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. While the methods 600 and 700 are described below with reference to the processor 104 and the system 102 as described above; other suitable systems for the execution of these methods may also be utilized. Additionally, implementation of these methods is not limited to such examples.

FIG. 6 illustrates the method 600 for assisting in modelling of a questionnaire, according to an example implementation of the present subject matter.

At block 602, a query corresponding to an offering may be received. In one example, the query may include textual content relevant to the offering.

At block 604, the textual content may be encoded into a set of query vectors. The set of query vectors may represent the textual content.

At block 606, a relevance metric may be computed for each elementary vector in a set of elementary vectors. In one example, the set of elementary vectors may be derived based on descriptive content, such as the descriptive content indicated by the data or documents 106 associated with the offering. As discussed above, the descriptive information may include information usable for deriving an insight associated with an aspect related to the offering. Further, the relevance metric may be computed for each elementary vector in the set of elementary vectors. In one example, the relevance metric may be computed by determining a semantic relationship between each elementary vector, in the set of elementary vectors, and each query vector in the set of query vectors.

At block 608, a set of relevant elementary vectors may be selected from amongst the set of elementary vectors. In one example, the set of relevant elementary vectors may be selected based on the relevance metric computed for each of the elementary vectors in the set of elementary vectors. Further, the set of relevant elementary vectors may indicate a portion of the descriptive information from amongst the descriptive information. The portion of the descriptive information, represented by the set of relevant elementary vectors, may be referred to as the selective descriptive information.

At block 610, modelling of a questionnaire may be triggered based on the set of relevant elementary vectors. In one example, the questionnaire may include hierarchically-linked questions in relation to the insight associated with the aspect. In one example, an advanced learning model may be triggered for modelling the questionnaire. The advanced learning model, in one example, may be a large language model. The advanced learning model may be capable modelling the questionnaire, as discussed above, as discussed above.

In one example, the questionnaire may be modelled by determining an opening question based on the set of relevant elementary vectors. The opening question may be determined in relation to the insight associated with the aspect. Further, a plurality of subsequent questions may be determined. In one example, each of the plurality of subsequent questions may be determined based on a response, from amongst two responses associated with an immediately preceding question, derived for the immediately preceding question. Each of the plurality of subsequent questions may be determined based on the response derived for the immediately preceding question. Further, in one example, determining of the subsequent questions may continue until a response to at least one question, from among the subsequent questions, provides the requisite insight associated with the aspect. That is, the determination of the subsequent questions may continue until the response to at least one question indicates a concluding insight associated with the aspect, for example, a final decision to recall the offering.

At block 612, a questionnaire delivery signal may be generated to cause rendering of the modelled questionnaire. In one example, the questionnaire delivery signal may cause rendering of the modelled questionnaire as the hierarchically-linked questions, indicating the requisite insight associated with the aspect related to the offering.

FIGS. 7A and 7B illustrate the method 700 for modelling a questionnaire, according to another example implementation of the present subject matter.

At block 702, a query corresponding to an offering may be received. In one example, the query may include textual content relevant to the offering. In one example, the query may be received by a processor, such as the processor 104 from a Graphical User Interface, such as the Graphical User Interface 402 discussed above. The Graphical User Interface may include a query-receiving area, such as the query-receiving area 404 that may be configured for receiving the question from a user interacting with the Graphical User Interface. Further, examples of the offering may include, but are not limited to, products, services, and platforms.

At block 704, the textual content may be encoded into a set of query vectors. The set of query vectors may represent the textual content. In one example, the processor 104 may convert the textual content into the set of query vectors using any of the techniques discussed above. The set of query vectors may be, in one example, numerical vectors derived based on the textual content of the query.

At block 706, a relevance metric may be computed for each elementary vector in a set of elementary vectors. In one example, the set of elementary vectors may be numerical vectors stored in a vector database, such as the vector database 110. In one example, the set of elementary vectors may be derived based on descriptive content, such as the descriptive content indicated by the data or documents 106 associated with the offering. As discussed above, the descriptive information may include information usable for deriving an insight associated with an aspect related to the offering. Withdrawal, modification, replacement, repair, or recall may be some of the aspects related to the offering, and the insight may be knowledge, conclusion, decision, or other similar derivatives about the aspects, that may be derived based on the descriptive information.

Further, the relevance metric may be computed for each elementary vector in the set of elementary vectors. In one example, the relevance metric may be computed by determining a semantic relationship between each elementary vector, in the set of elementary vectors, and each query vector in the set of query vectors. The relevance metric may indicate a measure or level of semantic similarity between each elementary vector, in the set of elementary vectors, and each query vector in the set of query vectors

At block 708, a set of relevant elementary vectors may be selected from amongst the set of elementary vectors. In one example, the set of relevant elementary vectors may be selected based on the relevance metric computed for each of the elementary vectors in the set of elementary vectors. In one example, to identify the set of relevant elementary vectors, the relevance metric, computed for each elementary vector, may be compared with a threshold relevance metric. The threshold relevance metric may indicate a minimum score required for the elementary vector to be considered semantically similar and be added to the set of relevant elementary vectors. Based on the comparison, the processor 104 may identify the set of relevant elementary vectors from amongst the set of elementary vectors. If the relevance metric for an elementary vector is equal to or greater than the threshold relevance metric, the elementary vector may probably be semantically similar to at least one query vector in the set of query vectors. The elementary vector may be selected for being added to the set of relevant elementary vectors. However, if the relevance metric for the elementary vector is less than the threshold relevance metric, the elementary vector may probably not be semantically similar to at least one query vector in the set of query vectors. The elementary vector may not be selected for being added to the set of relevant elementary vectors.

Thus, the set of relevant elementary vectors may include elementary vectors determined to be semantically relatable with the query vectors in the set of query vectors. Further, as the set of relevant elementary vectors is selected from amongst the set of elementary vectors, the set of relevant elementary vectors may indicate a portion of the descriptive information from amongst the descriptive information. The portion of the descriptive information, represented by the set of relevant elementary vectors, may be referred to as the selective descriptive information. Further, as the selective descriptive information is represented by the set of relevant elementary vectors having semantic relationship with the set of query vectors, the selective descriptive information may thus be pertinent to the query.

At block 710, an opening question may be determined based on the set of relevant elementary vectors. Once the set of relevant elementary vectors is selected, modelling of a questionnaire may be triggered. The modelled questionnaire may include questions that may be hierarchically-linked questions in relation to the insight associated with the aspect. As discussed above, a questionnaire modelling unit, such as the questionnaire modelling unit 302, may be triggered for modelling the questionnaire. In one example, an advanced learning model may be triggered for modelling the questionnaire. The advanced learning mode, in one example, may be a large language model that may be configured or trained with at least one of historically or previously modelled questionnaires, historically or previously derived responses for each question of the historically modelled questionnaires, aspects derived from each of the historically modelled questionnaires, and descriptive information associated with the offering. Based on such a vast dataset, the questionnaire modelling unit 302, which may either have deployed thereon or itself be the advanced learning model, may be configured to determine the questions for modelling the questionnaire, as discussed above. The questionnaire modelling unit 302, based on the set of relevant elementary vectors, may model the questionnaire by leveraging the extensive training or diverse sets of data, as discussed above.

Thus, in one example, using the questionnaire modelling unit 302, an opening question may be determined based on the set of relevant elementary vectors. The opening question may be determined in relation to the insight associated with the aspect. In one example, the opening question may be an initial or starting question directed towards determining whether to recall an offering. As the opening question may be directed towards determining whether to recall the offering, the opening question may thus be in relation to the insight associated with the aspect, for example, the decision to recall. Thus, the opening question 502 may be determined concerning the insight associated with the aspect, and the method 700 may flow to block A. In one example, the opening question may be “Was XYZ batch of a model of a car released without disk brakes?”

From block A and at block 712, it may be determined whether a response to an immediately preceding question is a first response. In one example, where only the opening question has been determined at that instance of time, the immediately preceding question may be the opening question. Based on the response to the opening question, i.e., the immediately preceding question, a plurality of subsequent questions may be determined.

In one example, a response for the opening question may be determined from amongst two responses. The two responses may include a first response and a second response. The first response may lead to determination of a subsequent question having an increased proximity to the insight associated with the aspect. In one example, the first response may be a positive response. For example, the first response may be “YES”, “TRUE”, or other similar responses. Whereas, the second response may lead to determination of a subsequent question having a reduced proximity to the insight associated with the aspect. In one example, the second response may be a negative response. For example, the second response may be “NO”, “FALSE”, or other similar responses. In one example, the proximity may be a measure of semantic similarity or logical closeness. Thus, if the insight associated with the aspect is, for example, a decision to recall, increased proximity may indicate more semantic similarity or logical closeness with respect to the decision to recall. Whereas, reduced proximity may indicate lesser semantic similarity or logical closeness with respect to the decision to recall.

Thus, a probable response to the opening question may be determined from amongst the first and the second responses. To determine the probable response, the selective descriptive information may be explored or analyzed and the probable response may be logically driven the for the opening question, as discussed above. If the probable response is determined to be the first response, for example, “YES”, the method may follow the YES path and flow to block 714, where a subsequent question (for example, subsequent to the opening question) may be determined. In one example, the subsequent question may be determined by the questionnaire modelling unit 302, as discussed above.

The subsequent question may be determined with increased proximity to the insight associated with the aspect. That is, the subsequent question may have an increased proximity or closeness to the insight associated with the aspect as compared to the opening question. As discussed above, the opening question may be a broad question directed towards the insight associated with the aspect. As discussed above, the opening question may be “Was XYZ batch of a model of a car released without disk brakes?”. If the probable response is determined to be “YES” the subsequent question may be determined and may be logically progressive (i.e., with increased semantic proximity) towards the insight associated with the aspect, i.e., decision to recall the XYZ batch. For example, if the selective descriptive information indicates that multiple customers have complained about brakes of their cars, the cars being of the XYZ batch, it may logically be driven that there may be a probable reason for such complaints with that specific batch. Thus, “YES” may be determined as the probable response. Thus, a logically progressive (i.e., with increased proximity) subsequent question towards the insight associated with the aspect, i.e., decision to recall the XYZ batch, may be determined. For example, the subsequent question, to the opening question, may be “can the issue of missing disk brake raise safety concerns?”.

However, on the other hand, if the probable response is determined to be the second response, for example, “NO”, the method may follow the NO path and flow to block 716 where a subsequent question may be determined. The subsequent question may be determined with reduced proximity to the insight associated with the aspect. That is, the subsequent question may logically regressive to the insight associated with the aspect, as compared to the opening question. As discussed above, the opening question may be “Was XYZ batch of a model of a car released without disk brakes?”. If the probable response is determined to be “NO” the subsequent question may be determined and may be logically regressive (i.e., with reduced semantic proximity) towards the insight associated with the aspect, i.e., decision to recall the XYZ batch. For example, if the datasheet indicates that there are no reports indicating missing disk brakes, it may logically be driven that there may be another probable reason for such complaints with that specific batch. Thus, “NO” may be determined as the probable response. Thus, a logically regressive subsequent question towards the insight associated with the aspect, i.e., decision to recall the XYZ batch, may be determined. For example, the subsequent question may be “Can there be any other issue that may cause the malfunctioning of brakes?”.

Further, in one example, determining the subsequent questions may continue until a response to at least one question, from among the subsequent questions, provides the requisite insight associated with the aspect. That is, the determination of the subsequent questions may continue until the response to at least one question indicates a concluding insight associated with the aspect, for example, a final decision on whether to recall the offering (for example, the XYZ batch).

The method 700 may continue to flow between blocks 712 to 716, for determining the subsequent questions until a response to at least one question, from among the subsequent questions, provides the requisite insight associated with the aspect. For example, if the response to the subsequent question “can the issue of missing disk brake raise safety concerns?” is determined to be the first response, the method may flow to block 714 to determine another subsequent question proximate to the insight associated with the aspect. However, if the response to the subsequent question “can the issue of missing disk brake raise safety concerns?” is determined to be the second response, the method may flow to block 716 to determine another subsequent question with further reduced proximity to the insight associated with the aspect.

Similarly, for the subsequent question “Can there be any other issue that may cause the malfunctioning of brakes?”, if the response is determined to be the first response, the method may flow to block 714 to determine another subsequent question proximate to the insight associated with the aspect. However, if the response to the subsequent question “Can there be any other issue that may cause the malfunctioning of brakes?” is determined to be the second response, the method may flow to block 716 to determine another subsequent question with further reduced proximity to the insight associated with the aspect.

Further, the process may continue until a response to at least one question, from among the subsequent questions, provides the requisite insight associated with the aspect. For example, if response to a question subsequent to the question “can the issue of missing disk brake raise safety concerns?” is determined to be the first response, it may be ascertained that the recall of XYZ batch should be processed (i.e., the concluding or requisite insight associated with the aspect). Since the process may be repeated, flow of the method 700 may be executed in a loop between blocks 712 to 716. After a response providing the requisite insight associated with the aspect is determined, the method 700 may flow to block 718. Therefore, flow of the method 700 from blocks 714 and 716, i.e., towards the block 718, has been illustrated with dashed lines. After the requisite or required insight is obtained, the method 700 may flow to block 718.

At block 718, a questionnaire delivery signal may be generated to cause rendering of a modelled questionnaire. By generating the questionnaire delivery signal, the processor 104 may cause rendering of the modelled questionnaire.

At block 720, the modelled questionnaire may be rendered, the questionnaire having hierarchically-linked questions where each of the subsequent is linked with the preceding question. In one example, the modelled questionnaire may be rendered as a REACT-based Graphical User Interface. In one example, the modelled questionnaire may be rendered as a decision tree. For example, a decision tree-like questionnaire may be rendered with the opening question and the subsequent questions, being hierarchically-linked and, finally, providing a concluding decision. In one example, the hierarchically-linked questions may indicate a hierarchy between the questions. As discussed above, each question may be derived from a probable response to its immediately preceding question, thus being linked in a hierarchical manner.

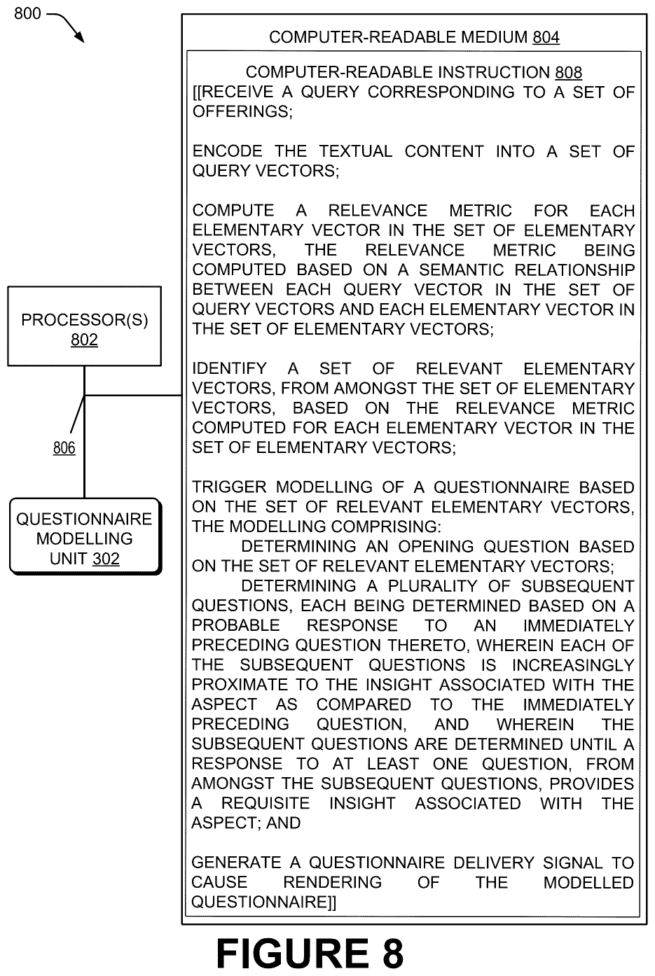

FIG. 8 illustrates a non-transitory computer-readable medium for modelling a questionnaire and determining a requisite insight associated with an aspect, in accordance with an example of the present subject matter.

In an example, the computing environment 800 includes a processor 802 communicatively coupled to a non-transitory computer-readable medium 804 through a communication link 806. In an example, the processor 802 may have one or more processing resources for fetching and executing computer-readable instructions from the non-transitory computer-readable medium 804. The processor 802 and the non-transitory computer-readable medium 804 may be implemented, for example, in the system 102.

The non-transitory computer-readable medium 804 may be, for example, an internal memory device or an external memory. In an example implementation, the communication link 806 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer-readable medium 804 includes a set of computer-readable instructions 808 which may be accessed by the processor 802 through the communication link 806 and subsequently executed for reconfiguring the data pipeline. The processor 802 and the non-transitory computer-readable medium 804 may also be communicatively coupled to a questionnaire modelling unit, such as the questionnaire modelling unit 302 over the communication link 806.

Referring to FIG. 8, in an example, the non-transitory computer-readable medium 804 includes computer-readable instructions 808 that may cause the processor 802 to receive a query corresponding to a set of offerings. In one example, the query may include textual content relevant to the set of offerings. The set of offerings may be, for example, at least one of a batch of products and one or more service offerings. In one example, the processor 802 may receive the query from a Graphical User Interface communicably coupled with the processor 802. In one example, the Graphical User Interface may be the Graphical User Interface 402, or another Graphical User Interface that may facilitate a user in submitting the query.

The instructions 808 may further cause the processor 802 to encode the textual content into a set of query vectors, as discussed above. The set of query vectors may numerically represent the textual content.

The instructions 808 may further cause the processor 802 to compute a relevance metric for each elementary vector in a set of elementary vectors. In one example, the set of elementary vectors may be derived based on the descriptive information associated with the set of offerings, as discussed above. In one example, the descriptive information may be similar to the information indicated in data or documents 106 and/or stored in the data storage unit 108. As discussed above, the descriptive information may include information contained within various documents and materials associated with the set of offerings and may thus be usable for deriving an insight associated with an aspect related to the set of offerings. Withdrawal, modification, replacement, or recall may be some of the aspects related to the set of offerings, and the insight may be knowledge, conclusion, decision, or other similar derivatives about the aspects, that may be derived based on the descriptive information. In one example, the descriptive information may be encoded into the set of elementary vectors, where the set of elementary vectors may collectively and numerically indicate the descriptive content, as discussed above.

Further, for each elementary vector, in the set of elementary vectors, the processor 802 may compute the relevance metric. In one example, the processor 802 may compute the relevance metric by determining a semantic relationship between each elementary vector, in the set of elementary vectors, and each query vector in the set of query vectors, as discussed above. In one example, each elementary vector in the set of elementary vectors may be compared with each query vector in the set of query vectors. Based on the comparison, the relevance metric may be computed. The relevance metric may indicate, for example, a score of semantic similarity or relationship between each elementary vector, in the set of elementary vectors, and each query vector in the set of query vectors.

Once the relevance metric has been computed for each elementary vector in the set of elementary vectors, the instructions 808 may further cause the processor 802 to identify a set of relevant elementary vectors from amongst the set of elementary vectors. The identification may be based on the relevance metric computed for each elementary vector, as discussed above. The set of relevant elementary vectors may include elementary vectors determined to be semantically related to the query vectors in the set of query vectors. The set of relevant elementary vectors may thus include elementary vectors that may probably be semantically relatable with the query vectors, and thus the query that was received by the processor 104.

Further, the set of relevant elementary vectors may indicate a portion of the descriptive information from amongst the descriptive information. The portion of the descriptive information represented by the set of relevant elementary vectors may be referred to as the selective descriptive information. Further, as the selective descriptive information is represented by the set of relevant elementary vectors having a semantic relationship with the set of query vectors, the selective descriptive information may thus be pertinent to the query.

The instructions 808 may further cause the processor 802 to trigger modelling of a questionnaire based on the set of relevant elementary vectors. In one example, the questionnaire may include hierarchically-linked questions in relation to the insight associated with the aspect. In one example, the processor 104 may utilize the questionnaire modelling unit 302, as discussed above, to model the questionnaire based on the given set of relevant elementary vectors.

In one example, to model the questionnaire, an opening question based on the set of relevant elementary vectors may be determined, as discussed above. The opening question may be determined in relation to the insight associated with the aspect. For example, the opening question may be a broad question directed towards determining a decision to withdraw the set of offerings.

Further, a plurality of subsequent questions may be determined. In one example, each of the plurality of subsequent questions may be determined based on a probable response to an immediately preceding question thereto. For example, the processor 104 may deduce a response to the opening question based on logical analysis and assessment of the portion of the descriptive information indicated by the set of relevant elementary vectors. In another example, the response may be determined based on logical analysis and assessment of the complete descriptive information. Based on the response, a subsequent question may accordingly be determined. In one example, the subsequent questions may be determined in such a manner that proximity to the insight associated with the aspect is increased as compared to the immediately preceding question. For example, the opening question may have a broad scope whereas the subsequent question may have a narrower scope and may be more semantically directed towards the insight associated with the aspect as compared to the opening question. Thus, each subsequent question may be a question whose response may be closer to the required or requisite insight associated with the aspect, for example, a response to the decision to withdraw the set of offerings.

Further, determination of the subsequent questions may continue until a response to at least one question, from among the subsequent questions, provides the required insight associated with the aspect. That is, the processor 802 may continue to determine the subsequent questions until the response to at least one question indicates a concluding insight associated with the aspect, for example, a concluding response or decision to withdraw the set of offerings.

Once the questionnaire has been modelled, the instructions 808 may further cause the processor 802 to generate a questionnaire delivery signal to cause rendering of the modelled questionnaire. In one example, the questionnaire delivery signal may cause rendering of the modelled questionnaire as the hierarchically-linked questions.

In response to the generation of the questionnaire delivery signal, the instructions 808 may further cause the processor 802 to render the modelled questionnaire having hierarchically-linked questions, where each of the subsequent questions may be linked with the preceding question.

Further, instructions 808 may further cause the processor 802 to render a feedback option to receive at least one of a positive feedback and a negative feedback. In one example, the feedback option may be the feedback option 508, discussed above, having the buttons 1 and 2 that may facilitate submission of feedback for each of the questions in the modelled questionnaire. For example, the button 1 may be designated to indicate the positive feedback and the button 2 may be designated to indicate the negative feedback for a question.

The user may provide feedback by interacting with any of the buttons 1 and 2. For example, if the user determines that the question, say a subsequent question is acceptable or relevant to the insight associated with the aspect, the user may interact, say hover over the button 1. The positive feedback may thus indicate acceptance of the question. However, if the user determines that a question is unacceptable or irrelevant to the insight associated with the aspect, the user may interact, say hover over the button 2. The negative feedback may thus indicate rejection of the question.

In one example, the instructions 808 may further cause the processor 802 to render an updated questionnaire based on the response received on the feedback option. For example, the instructions 808 may further cause the processor 802 to render a re-arranged questionnaire by removing the question for which the negative feedback was received.

Further, the instructions 808 may further cause the processor 802 to tune subsequent determination of at least one of the opening question and subsequent questions based on the positive feedback and the negative feedback. Based on the positive and the negative feedback, the processor 802 may be able to determine whether the questions in the modelled questionnaire are relevant to the insight associated with the aspect. For example, if positive feedback was received for majority of the question, the processor 802 may record such feedback and tune the method or logic to keep determining the subsequent question similarly when the same or similar insight associated with an aspect is required to be determined. However, if negative feedback was received for any, all, or the majority of the questions, the processor 802 may record such feedback and tune the logic to avoid determining the subsequent question in a similar manner when the same or similar insight associated with an aspect is required to be determined. The positive and the negative feedback may thus be used for tuning the modelling of the questionnaire.

Although examples of the present subject matter have been described in language specific to system, methods, and/or structural features, it is to be understood that the present subject matter is not limited to the specific systems, methods, or features described. Rather, the systems, methods, and specific features are disclosed and explained as examples of the present subject matter.

What is claimed is:

1. A system comprising:
a processor to:
receive an activation signal comprising a query corresponding to an offering, the query comprising textual content relevant to the offering;
encode the textual content into a set of query vectors, the set of query vectors being representative of the textual content;
compute, from a vector database having a set of elementary vectors derived based on descriptive information associated with the offering, a relevance metric for each elementary vector in the set of elementary vectors, the relevance metric being computed based on a semantic relationship between each query vector in the set of query vectors and each elementary vector in the set of elementary vectors, wherein the descriptive information comprises information usable for deriving an insight associated with an aspect related to the offering;
identify a set of relevant elementary vectors, from amongst the set of elementary vectors, based on the relevance metric computed for each elementary vector in the set of elementary vectors, the set of relevant elementary vectors being representative of selective descriptive information, from amongst the descriptive information, pertinent to the query;
trigger modelling of a questionnaire based on the set of relevant elementary vectors, the questionnaire comprising questions being hierarchically-linked questions in relation to the insight associated with the aspect, the modelling comprising:
determining an opening question, in relation to the insight associated with the aspect, based on the set of relevant elementary vectors;
determining a plurality of subsequent questions, each being determined based on a probable response to an immediately preceding question thereto, the probable response being derived from the selective descriptive information encoded as the set of relevant elementary vectors, wherein each of the subsequent questions is increasingly proximate to the insight associated with the aspect as compared to the immediately preceding question, and
wherein the subsequent questions are determined until a response to at least one question, from amongst the subsequent questions, provides a requisite insight associated with the aspect; and
generate a questionnaire delivery signal to cause rendering of the modelled questionnaire.

2. The system of claim 1, the system further comprising the vector database communicably coupled with the processor, the vector database having stored therein the set of elementary vectors derived based on the descriptive information associated with the offering.

3. The system of claim 1, wherein the processor is to cause rendering of the modelled questionnaire having the hierarchically-linked questions, wherein each of the subsequent questions is linked with the preceding question, the subsequent questions having increased proximity towards the insight as compared to the preceding question thereto.

4. The system of claim 1, wherein the processor is to receive, from an actionable component, a questionnaire modification signal indicating a request to modify at least one of the questions of the modelled questionnaire.

5. The system of claim 1, wherein the processor is to cause rendering of a feedback option to receive at least one of a positive feedback and a negative feedback for each question of the modelled questionnaire, the positive feedback indicating acceptance of the question and the negative feedback indicating rejection of the question.

6. The system of claim 5, wherein the processor is to render an updated questionnaire in response to receiving the negative feedback for the question.

7. The system of claim 5, wherein the processor is to tune subsequent determinations of at least one of an opening question and subsequent questions based on at least one of the positive feedback and the negative feedback.

8. The system of claim 1, wherein the processor is to trigger an advanced learning model for modelling the questionnaire, wherein the advanced learning model is one of a supervised large language model and an unsupervised large language model.

9. The system of claim 1, wherein the modelled questionnaire further comprises the query, wherein the opening question is hierarchically linked with the query, the opening question being increasingly proximate, compared to the query, towards the insight associated with the aspect.

10. The system of claim 1, wherein the processor is to:
compare the relevance metric, computed for each elementary vector in the set of elementary vectors, with a threshold relevance metric; and
identify, based on the comparison, the set of relevant elementary vectors from amongst the set of elementary vectors.

11. A method comprising:
receiving a query corresponding to an offering, the query comprising textual content relevant to the offering;
encoding the textual content into a set of query vectors, the set of query vectors being representative of the textual content;
computing, from a set of elementary vectors derived based on descriptive information associated with the offering, a relevance metric for each elementary vector in the set of elementary vectors, the relevance metric being computed based on a semantic similarity between each query vector in the set of query vectors and each elementary vector in the set of elementary vectors, wherein the descriptive information comprises information usable for deriving an insight associated with an aspect related to the offering;
selecting a set of relevant elementary vectors, from amongst the set of elementary vectors, based on the relevance metric computed for each elementary vector in the set of elementary vectors, the set of relevant elementary vectors being representative of selective descriptive information, from amongst the descriptive information, pertinent to the query;
triggering modelling of a questionnaire based on the set of relevant elementary vectors, the questionnaire comprising questions being hierarchically-linked questions in relation to the insight associated with the aspect, the modelling comprising:
determining an opening question, in relation to the insight associated with the aspect, based on the set of relevant elementary vectors;
determining a plurality of subsequent questions, each being determined based on a response, from amongst two responses associated with an immediately preceding question, derived for the immediately preceding question, the response being derived based on the selective descriptive information encoded as the set of relevant elementary vectors, wherein the subsequent questions are determined until a response to at least one question, from amongst the subsequent questions, provides a required insight associated with the aspect; and
generating a questionnaire delivery signal to cause rendering of the modelled questionnaire.

12. The method of claim 11, wherein the two responses comprise a first response and a second response, wherein, upon derivation of the first response as the response for the immediately preceding question, a question with increased proximity to the insight associated with the aspect is determined, and wherein, upon derivation of the second response as the response for the immediately preceding question, another question with reduced proximity to the insight is determined, the other question being distinct from the question with increased proximity.

13. The method of claim 11, wherein triggering modelling of the questionnaire comprises triggering of an advanced learning model.

14. The method of claim 13, the method further comprising configuring the advanced learning model based on at least one of historically modelled questionnaires, historically derived responses for each question of the historically modelled questionnaires, aspects derived from each of the historically modelled questionnaires, and descriptive information associated with the offering.

15. The method of claim 11, wherein the aspect is related to recall of the offering.

16. The method of claim 11, rendering, in response to generation of the questionnaire delivery signal, the modelled questionnaire having the hierarchically-linked questions, wherein each of the subsequent questions is linked with the preceding question.

17. A non-transitory computer-readable medium comprising instructions, the instructions being executable by a processing resource to:
receive a query corresponding to a set of offerings, the query comprising textual content relevant to the set of offerings;
encode the textual content into a set of query vectors, the set of query vectors numerically representing the textual content;
compute, from a vector database having a set of elementary vectors derived based on descriptive information associated with the set of offerings, a relevance metric for each elementary vector in the set of elementary vectors, the relevance metric being computed based on a semantic relationship between each query vector in the set of query vectors and each elementary vector in the set of elementary vectors, wherein the descriptive information comprises information usable for deriving an insight associated with an aspect related to the set of offerings;
identify a set of relevant elementary vectors, from amongst the set of elementary vectors, based on the relevance metric computed for each elementary vector in the set of elementary vectors, the set of relevant elementary vectors being representative of selective descriptive information, from amongst the descriptive information, pertinent to the query;
trigger modelling of a questionnaire based on the set of relevant elementary vectors, the questionnaire comprising questions being hierarchically-linked questions in relation to the insight associated with the aspect, the modelling comprising:
determining an opening question, in relation to the insight associated with the aspect, based on the set of relevant elementary vectors;
determining a plurality of subsequent questions, each being determined based on a probable response to an immediately preceding question thereto, the probable response being derived from the selective descriptive information, wherein each of the subsequent questions is increasingly proximate to the insight associated with the aspect as compared to the immediately preceding question, and
wherein the subsequent questions are determined until a response to at least one question, from amongst the subsequent questions, provides a requisite insight associated with the aspect; and
generate a questionnaire delivery signal to cause rendering of the modelled questionnaire.

18. The non-transitory computer-readable medium of claim 17, wherein the set of offerings comprises at least one of a batch of products and one or more service offerings.

19. The non-transitory computer-readable medium of claim 17, the instructions being executable by the processing resource to render, in response to generation of the questionnaire delivery signal, the modelled questionnaire having the hierarchically-linked questions, wherein each of the subsequent questions is linked with the preceding question.

20. The non-transitory computer-readable medium of claim 17, the instructions being executable by the processing resource to:
render a feedback option to receive at least one of a positive feedback and a negative feedback for each question of the modelled questionnaire, the positive feedback indicating acceptance of the question and the negative feedback indicating rejection of the question;
render an updated questionnaire based on the response received on the feedback option; and
tune subsequent determinations of at least one of an opening question and subsequent questions based on the positive feedback and the negative feedback.
